(19) United States
(12) Patent Application Publication
(10) Pub. No.: US 2014/0345805 A1
(43) Pub. Date: Nov. 27, 2014

(54) SUBSTRATE HOLDER AND SUBSTRATE BONDING APPARATUS

(71) Applicant: NIKON CORPORATION, Tokyo (JP)

(72) Inventors: Hidehiro MAEDA, Yokohama-shi (JP); Isao SUGAYA, Kawasaki-shi (JP); Naohiko KURATA, Tokyo (JP); Hiroshi MORI, Tokyo (JP)

(21) Appl. No.: 14/303,926

(22) Filed: Jun. 13, 2014

Related U.S. Application Data
(63) Continuation of application No. PCT/JP2012/008001, filed on Dec. 14, 2012.

(30) Foreign Application Priority Data
Dec. 14, 2011 (JP) 2011-273554

(51) Int. Cl. B32B 38/18

(52) U.S. Cl. CPC B32B 38/18; B32B 2038/1891
USPC 156/538

(57) ABSTRACT

A substrate holder that holds a substrate when the substrate is being aligned with another substrate and transports the substrate in a held state, comprising a mounting portion on which the substrate is mounted; a supported section that is provided on the mounting portion and is supported by another member during transport; and a restricting section that restricts damage from stress caused by a difference in expansion and contraction due to heat between the mounting portion and the supported section.

### BACKGROUND

1. TECHNICAL FIELD

The present invention relates to a substrate holder and a substrate bonding apparatus.

2. Related Art

A method is known that includes heating a plurality of substrates in a stacked state held by a substrate holder in order to bond these substrates to each other, such as shown in Patent Document 1, for example.

Patent Document 1: Japanese Patent Application Publication No. 2011-216833

However, there is a problem that damage is caused by the expansion of the substrate holder due to the heating.

### SUMMARY

Therefore, it is an object of an aspect of the innovations herein to provide a substrate holder and a substrate bonding apparatus, which are capable of overcoming the above drawbacks accompanying the related art. The above and other objects can be achieved by combinations described in the claims. According to a first aspect of the present invention, provided is a substrate holder that holds a substrate when the substrate is being aligned with another substrate and transports the substrate in a held state, comprising a mounting portion on which the substrate is mounted; a supported section that is provided on the mounting portion and is supported by another member during transport; and a restricting section that restricts damage from stress caused by a difference in expansion and contraction due to heat between the mounting portion and the supported section.

According to a second aspect of the present invention, provided is a substrate holder that holds a substrate, comprising a mounting portion on which the substrate is mounted; a supported section that is provided around the mounting portion and is supported by another member; and an absorbing section that absorbs deformation of the supported section in a circumferential direction of the mounting portion when the mounting portion expands and contracts due to heat.

According to a third aspect of the present invention, provided is a substrate bonding apparatus comprising the substrate holder according to the first aspect; and a bonding section that bonds a plurality of the substrates, in a state where the substrates are held by the substrate holder.

The summary clause does not necessarily describe all necessary features of the embodiments of the present invention. The present invention may also be a sub-combination of the features described above.

### BRIEF DESCRIPTION OF THE DRAWINGS

FIG. 1 is an overall schematic view of a substrate bonding apparatus 10.

FIG. 2 is used to describe the bonding of the bonded substrate 95 by the substrate bonding apparatus 10.

FIG. 3 is used to describe the bonding of the bonded substrate 95 by the substrate bonding apparatus 10.

FIG. 4 is used to describe the bonding of the bonded substrate 95 by the substrate bonding apparatus 10.

FIG. 5 is used to describe the bonding of the bonded substrate 95 by the substrate bonding apparatus 10.

FIG. 6 is used to describe the bonding of the bonded substrate 95 by the substrate bonding apparatus 10.

FIG. 7 is used to describe the bonding of the bonded substrate 95 by the substrate bonding apparatus 10.

FIG. 8 is a bottom view of the upper substrate holder 100, which is one of the substrate holders 94.

FIG. 9 is a perspective view of the upper substrate holder 100 as seen from above.

FIG. 10 is an enlarged planar view of the region near the upper absorbing portion 110 surrounded by the dotted line X in FIG. 8.

FIG. 11 is a vertical cross-sectional view along the line X1-X1 of FIG. 8, and is used to describe an exemplary upper connecting portion 112.

FIG. 12 is a top view of the lower substrate holder 200, which is the other substrate holder 94.

FIG. 13 is a perspective view of the lower substrate holder 200 as seen from above.

FIG. 14 is a top view of the altered upper substrate holder 100.

FIG. 15 is a top view of the lower substrate holder 200 with an altered portion corresponding to the upper substrate holder 100 of FIG. 14.

FIG. 16 is a vertical cross-sectional view of an exemplary lower fastening portion 248 along the line X2-X2 shown in FIG. 15.

FIG. 17 is a vertical cross-sectional view of an exemplary lower locking portion 250 along the line X3-X3 shown in FIG. 15.

FIG. 18 is a vertical cross-sectional view of another exemplary lower locking portion 256 along the line X3-X3 shown in FIG. 15.

FIG. 19 is a vertical cross-sectional view of another exemplary lower locking portion 258 along the line X3-X3 shown in FIG. 15.

FIG. 20 is a bottom view of the altered upper substrate holder 100.

FIG. 21 is a top view of the altered lower substrate holder 200 corresponding to the upper substrate holder 100 of FIG. 20.

FIG. 22 is a vertical cross-sectional view of an exemplary lower sliding connection portion 288 along the line X4-X4 shown in FIG. 21.

FIG. 23 is a vertical cross-sectional view of another lower sliding connection portion 288 along the line X4-X4 shown in FIG. 21.

FIG. 24 is a vertical cross-sectional view of another lower sliding connection portion 290 along the line X4-X4 shown in FIG. 21.

FIG. 25 is a perspective view for describing an exemplary lower sliding connection portion 290 shown in FIG. 24.

FIG. 26 is a perspective view for describing another exemplary lower sliding connection portion 290 shown in FIG. 24.

FIG. 27 is a top view of the altered upper substrate holder 100.

FIG. 28 is a top view of a lower substrate holder 200 with an altered portion, corresponding to the upper substrate holder 100 of FIG. 27.

FIG. 29 is a vertical cross-sectional view for describing an exemplary connection between the upper electrode pad 106 and the frame 146.

FIG. 30 is a vertical cross-sectional view of an embodiment in which the support structure of the upper mounting portion 102 and the upper ear portion 104 is altered.

FIG. 31 is a side view of an embodiment in which a plurality of substrates 90 is sandwiched by a single substrate holder 300.

FIG. 32 is a planar view of the substrate holder 300.

FIG. 33 is a side view for describing another example of sandwiching a plurality of the substrates 90 with a single substrate holder 300.

FIG. 34 is a side view for describing another example of sandwiching a plurality of the substrates 90 with a single substrate holder 300.

FIG. 35 is a side view for describing another example of sandwiching a plurality of the substrates 90 with a single substrate holder 300.

FIG. 36 is a side view for describing another example of sandwiching a plurality of the substrates 90 with a single substrate holder 300.

FIG. 37 is a side view for describing another example of the supported section

FIG. 38 is a side cross-sectional view for describing a state in which the lower mounting portion 368 and the upper mounting portion 342 of FIG. 37 are mounted on the thermocompression plate 348.

FIG. 39 is a perspective view describing a state in which the lower substrate holder 400 is transported to the robot arm 352.

FIG. 40 is an enlarged perspective view of the region near the suction unit 354 surrounded by the dotted line Y in FIG. 40.

FIG. 41 is a vertical cross-sectional view over the line X5-X5 of FIG. 41, for describing the suction unit 354.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

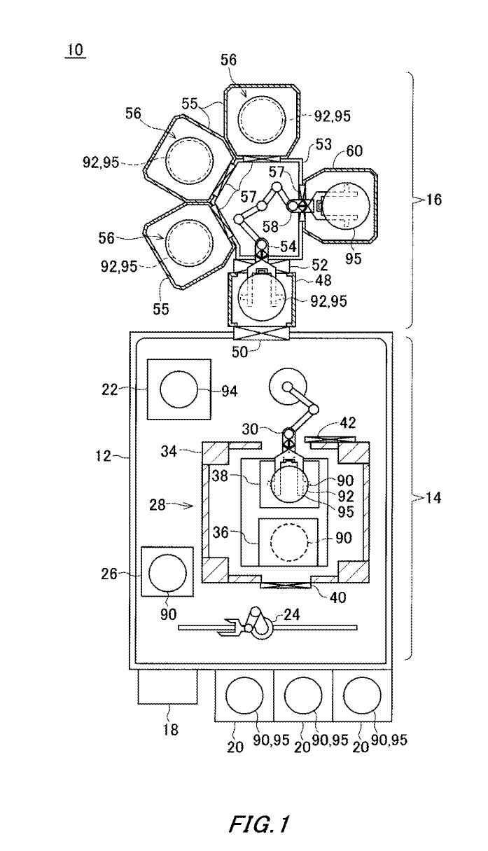

FIG. 1 is an overall schematic view of a substrate bonding apparatus 10. The substrate bonding apparatus 10 bonds two substrates 90, to manufacture a bonded substrate 95. The substrate bonding apparatus 10 may instead bond three or more substrates 90 at once to manufacture the bonded substrate 95.

As shown in FIG. 1, the substrate bonding apparatus 10 includes as atmosphere environment section 14, a vacuum environment section 16, and a control section 18.

The atmosphere environment section 14 includes an environment chamber 12, a plurality of substrate cassettes 20, a substrate holder rack 22, a robot arm 24, a pre-aligner 26, an aligner 28, and a robot arm 30. The environment chamber 12 is formed to surround the atmosphere environment section 14.

The substrate cassette 20 houses the substrates 90 to be bonded by the substrate bonding apparatus 10. The substrate cassette 20 houses the bonded substrates 95 resulting from the bonding by the substrate bonding apparatus 10. The substrate cassette 20 can be attached to and detached from an outer surface of the environment chamber 12. In this way, a plurality of substrates 90 can be mounted in the substrate bonding apparatus 10 at once. Furthermore, a plurality of sets of bonded substrates 95 can be recovered at once. The substrates 90 bonded by the substrate bonding apparatus 10 may be single silicon wafers, composite semiconductor wafers, glass substrates, or the like, and may have elements, circuits, terminals, or the like formed thereon. Furthermore, the mounted substrates 90 may be bonded substrates 95 that have already been formed by stacking a plurality of wafers.

The substrate holder rack 22 houses a plurality of pairs of substrate holders 94 that hold the bonded substrates 95 and multilayered substrate 92 formed by a stacked pair of substrates 90 from above and below. The substrate holder 94 holds the two substrates 90 of each set of the bonded substrate 95 and the multilayered substrate 92 using electrostatic adhesion.

The robot arm 24 is within the environment chamber 12 and arranged near the substrate cassette 20. The robot arm 24 transports a substrate 90 mounted in the substrate cassette 20 to the pre-aligner 26. The robot arm 24 transports the substrate 90 of the pre-aligner 26 to the substrate holder 94 mounted on the movable stage 38 of the aligner 28, which is described further below. After the bonding, the robot arm 24 transports the bonded substrate 95 that has been transported to the movable stage 38 to one of the substrate cassettes 20.

The pre-aligner 26 is within the environment chamber 12 and arranged near the robot arm 24. When mounting a substrate 90 in the aligner 28, the pre-aligner 26 tentatively aligns each of the substrates 90 with a relatively high accuracy such that enables the substrates 90 to be mounted within the narrow range of adjustment of the aligner 28. In this way, the positioning of the substrates 90 by the aligner 28 can be performed quickly and accurately.

The aligner 28 is arranged between the robot arm 24 and the robot arm 30. The aligner 28 includes a frame 34, a fixed stage 36, a movable stage 38, and a pair of shutters 40 and 42. The robot arms 24 and 30 are examples of a transporting section.

The frame 34 is formed to surround the fixed stage 36 and the movable stage 38. The substrate cassette 20 side surface of the frame 34 and the vacuum environment section 16 side surface of the frame 34 have openings formed therein, to enable the substrates 90, multilayered substrates 92, and bonded substrate 95 to be transported in and out.

The fixed stage 36 is inside the frame 34 and fixed near the substrate cassette 20. The bottom surface of the fixed stage 36 adheres the substrate holder 94, which has been transported from the movable stage 38 by the robot arm 30 in a state held by the substrate 90, to the bottom surface thereof using vacuum adhesion.

The movable stage 38 is inside the frame 34 and arranged on the vacuum environment section 16 side. The substrate 90 and the substrate holder 94 are adhered to the top surface of the movable stage 38 using vacuum adhesion. The movable stage 38 moves within the frame 34 in both a horizontal direction and a vertical direction. Therefore, by moving the movable stage 38, the substrate 90 and the substrate holder 94 held by the fixed stage 36 are aligned with the substrate 90 and the substrate holder 94 held by the movable stage 38, and then stacked. The stacked substrates 90 may be tentatively bonded with an adhesive, or may be tentatively bonded with plasma.

The shutter 40 opens and closes the opening on the substrate cassette 20 side of the frame 34. The shutter 42 opens and closes the opening on the vacuum environment section 16 side of the frame 34. The region surrounded by the frame 34, the shutter 40, and the shutter 42 is connected to an air conditioner or the like to adjust the temperature thereof. In this way, the alignment accuracy between the substrates 90 can be improved.

The robot arm 30 is within the environment chamber 12, and is arranged between the vacuum environment section 16 and the aligner 28. The robot arm 30 transports the substrate holder 94 housed in the substrate holder rack 22 to the movable stage 38. The substrate holder 94 mounted on the movable stage 38 holds the substrate 90, which is transported from the pre-aligner 26 by the robot arm 24, using electrostatic adhesion. The robot arm 30 flips and transports the substrate holder 94, which is mounted on the movable stage 38 and holds the substrate 90, to the fixed stage 36. The bottom surface of the fixed stage 36 adheres the substrate holder 94, which is transported by the robot arm 30, thereto along with the substrate 90 using vacuum adhesion. The robot arm 30 adheres the substrate holder 94 and the multilayered substrate 92, which includes the pair of substrates 90 aligned by the movable stage 38, thereto using vacuum adhesion and transports the substrate holder 94 and multilayered substrate 92 to the vacuum environment section 16. The robot arm 30 transports the bonded substrate 95 from the vacuum environment section 16 to the movable stage 38.

During the step of bonding by the substrate bonding apparatus 10, the vacuum environment section 16 is set to have a high temperature and be in a vacuum state. The vacuum environment section 16 includes a load lock chamber 48, an access door 50 and a gate valve 52 forming a pair, a robot arm 54, three housing chambers 55, three thermocompression apparatuses 56, a robot arm 58, and a cooling room 60. The number of thermocompression apparatuses 56 is not limited to three, and can be set as needed. The robot arm 54 is an example of a transporting section.

The load lock chamber 48 connects the atmosphere environment section 14 and the vacuum environment section 16. The load lock chamber 48 can be set to have a vacuum state and higher pressure. Openings are formed on the atmosphere environment section 14 side and vacuum environment section 16 side of the load lock chamber 48, in order to allow for transport of the bonded substrate 95 and the multilayered substrate 92 including the pair of substrates 90 held by the pair of substrate holders 94.

The access door 50 opens and closes the atmosphere environment section 14 side opening of the load lock chamber 48. The access door 50 is opened after air is introduced to the load lock chamber 48 via a port (not shown), i.e. the load lock chamber 48 is opened to the atmosphere, and a pressure gauge is used to confirm that the pressure in the load lock chamber 48 is equal to atmospheric pressure. In this way, the load lock chamber 48 is connected to the atmosphere environment section 14. In this state, the robot arm 30 transports the multilayered substrates 92 and the bonded substrates 95 between the load lock chamber 48 and the aligner 28.

The gate valve 52 opens and closes the vacuum environment section 16 side opening of the load lock chamber 48. The gate valve 52 is opened when the air is expelled from the load lock chamber 48 via a port, i.e. the load lock chamber 48 is made a vacuum, and the load lock chamber 48 enters a vacuum state in which the pressure is substantially equal to that of the robot chamber 53. In this way, the load lock chamber 48 is connected to the vacuum environment section 16. During the bonding, the access door 50 and the gate valve 52 are never in an open state.

The robot arm 54 is housed within the robot chamber 53. The robot arm 54 transports the multilayered substrate 92, which has been transported to the load lock chamber 48 by the robot arm 30, to one of the thermocompression apparatuses 56, and the gate valve 52 is closed.

The housing chamber 55 is formed to be hollow. The housing chamber 55 is connected to the robot chamber 53 via the gate valve 57. The gate valve 57 seals the housing chamber 55 that has returned to having normal atmosphere during maintenance. The housing chamber 55 houses and encompasses the main components of the thermocompression apparatus 56. The housing chamber 55 opens and closes the gate valve 57 in order to transport the multilayered substrate 92 and the bonded substrate 95 in and out. After the multilayered substrate 92 has been transported into the housing chamber 55, the gate valve 57 is closed and sealed in order to prevent gas generated by heat from leaking into the robot chamber 53. With the multilayered substrate 92 in a heated state, the housing chamber 55 is set to a vacuum state and the heat generated by the heating is blocked off.

The three thermocompression apparatuses 56 are arranged in a circle centered on the robot arm 54. In this way, each of the three thermocompression apparatuses 56 can be reached by the robot arm 54. The thermocompression apparatuses 56 are configured to enable heating and pressuring of the multilayered substrate 92. In the present embodiment, the thermocompression apparatuses 56 heat and pressure the multilayered substrate 92 by heating and pressuring the substrate holder 94 that holds the multilayered substrate 92. The thermocompression apparatuses 56 can bond the multilayered substrate 92 that has been transported from the load lock chamber 48.

The robot arm 58 is arranged to be able to pivot while centered in the robot chamber 53. In this way, the robot arm 58 transports the bonded substrate 95 from the thermocompression apparatus 56 to the cooling room 60. The robot arm 58 can transport the bonded substrate 95 from the cooling room 60 to the load lock chamber 48.

The cooling room 60 has a cooling function. In this way, the cooling room 60 can cool the high-temperature bonded substrate 95 that is connected by the robot arm 58. The cooling room 60 is configured to be able to be set in a vacuum state. The cooling room 60 is connected to the robot chamber 53 via the gate valve 57.

The control section 18 controls the overall operation of the substrate bonding apparatus 10. The control section 18 has a manipulation portion that is manipulated by a user when performing various settings, turning on the power, or performing various other operations for the substrate bonding apparatus 10. Furthermore, the control section 18 has an on-line connection to the outside. In this way, the control section 18 can acquire recipes of a host computer in a semiconductor factory and manage the progression of processes.

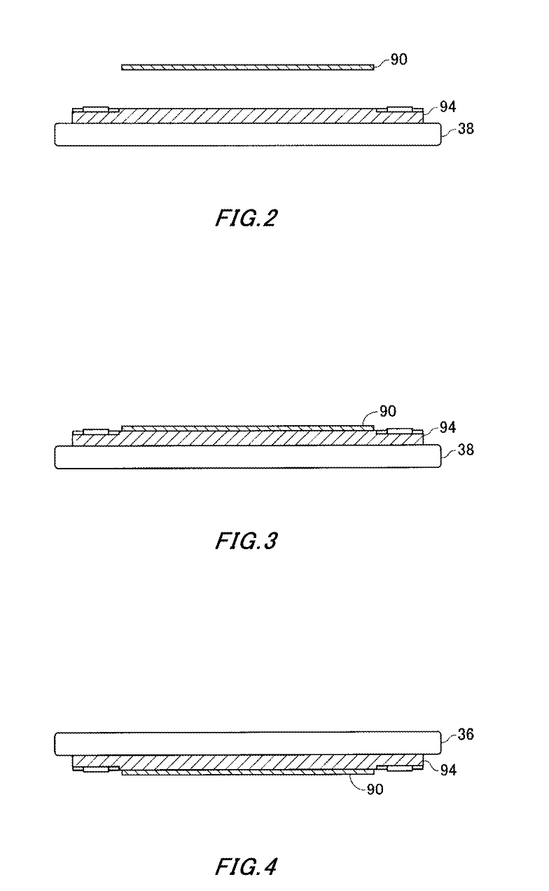

FIGS. 2 to 7 are used to describe the bonding of the bonded substrate 95 by the substrate bonding apparatus 10. In the bonding step, first, the robot arm 24 transports a substrate 90 in one of the substrate cassettes 20 to the pre-aligner 26. Next, in the positioning step, as shown in FIG. 2, the robot arm 30 transports a substrate holder 94 from the substrate holder rack 22 to the movable stage 38. The movable stage 38 adheres the substrate holder 94 thereto using vacuum adhesion. The robot arm 24 transports the substrate 90, which has had its position adjusted by the pre-aligner 26, to a position above the substrate holder 94 that is mounted on the movable stage 38.

Next, as shown in FIG. 3, the robot arm 24 mounts the substrate 90 on the substrate holder 94. The substrate holder 94 adheres the mounted substrate 90 thereto using electrostatic adhesion. The robot arm 30 flips and transports the substrate holder 94 holding the substrate 90 from the movable stage 38 to the fixed stage 36. As shown in FIG. 4, after receiving the substrate 90 and substrate holder 94 from the robot arm 30, the fixed stage 36 holds the substrate holder 94 using vacuum adhesion.

Next, using the same type of operation, the robot arm 30 transports the substrate holder 94 to the movable stage 38 and then the robot arm 24 transports the substrate 90 to the substrate holder 94 on the movable stage 38. In this way, as shown in FIG. 5, the movable stage 38 holds the substrate 90 and the substrate holder 94 with the substrate 90 on top, and the fixed stage 36 holds the substrate 90 and the substrate holder 94 with the substrate 90 on the bottom. After the shutters 40 and 42 are closed, the movable stage 38 holds the substrate 90 and the substrate holder 94 while moving to a position below the fixed stage 36 holding the other substrate 90 and substrate holder 94. The movable stage 38 is moved to a position at which a plurality of marks formed on the two substrates 90 statistically match positions, by observing the positions of the marks. In this way, the substrate 90 of the movable stage 38 and the substrate 90 of the fixed stage 36 are positioned relative to each other.

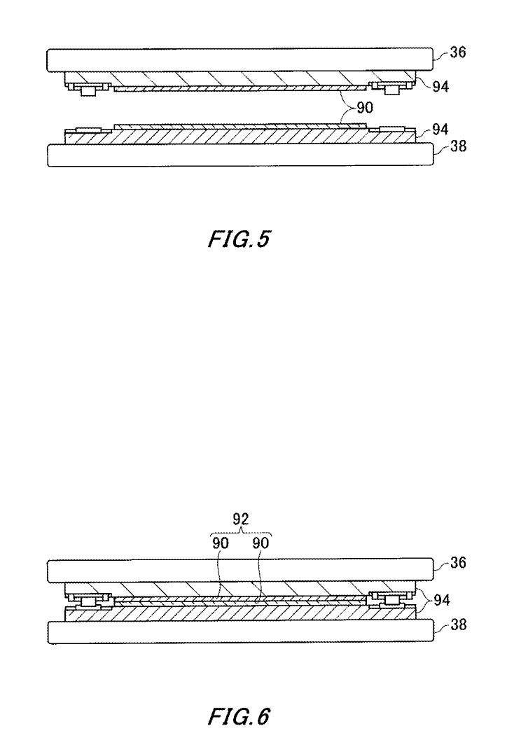

Next, as shown in FIG. 6, the movable stage 38 moves upward to put together the top surface of the substrate 90 on the movable stage 38 and the bottom surface of the substrate 90 on the fixed stage 36. After the vacuum adhesion exerted on the substrate holder 94 by the fixed stage 36 is released, with the movable stage 38 exerting vacuum adhesion on the substrate holder 94 holding the multilayered substrate 92, the movable stage 38 moves in the direction of the robot arm 30.

Next, during the transport step, the multilayered substrate 92 including the two substrates 90 positioned relative to each other is transported. Specifically, the access door 50 is opened to connect the load lock chamber 48 and the atmosphere environment section 14. The gate valve 52 is in a closed state, thereby maintaining the vacuum state in the robot chamber 53, the housing chamber 55, and the cooling room 60. In this state, the robot arm 30 transports the multilayered substrate 92 on the movable stage 38 to the load lock chamber 48. After this, the access door 50 is closed and the load lock chamber 48 is made to be in a vacuum state, and then the gate valve 52 is opened and the load lock chamber 48 is isolated from the atmosphere environment section 14 and connected to the vacuum environment section 16. In this state, the robot arm 54 transports the multilayered substrate 92 from the load lock chamber 48 to the thermocompression apparatus 56, and the gate valve 52 is closed.

Next, in the bonding step, the thermocompression apparatus 56 heats the multilayered substrate 92 to a temperature for achieving bonding, and then the multilayered substrate 92 is pressed from above and below while maintaining this bonding temperature. In this way, the substrates 90 of the multilayered substrate 92 are bonded to form the bonded substrate 95. After this, the robot arm 58 transports the bonded substrate 95 into the cooling room 60. The cooling room 60 cools the bonded substrate 95.

Next, the inside of the load lock chamber 48 is set to a vacuum state, and then the gate valve 52 is opened. The robot arm 58 transports the cooled bonded substrate 95 and substrate holder 94 from the cooling room 60 to the load lock chamber 48.

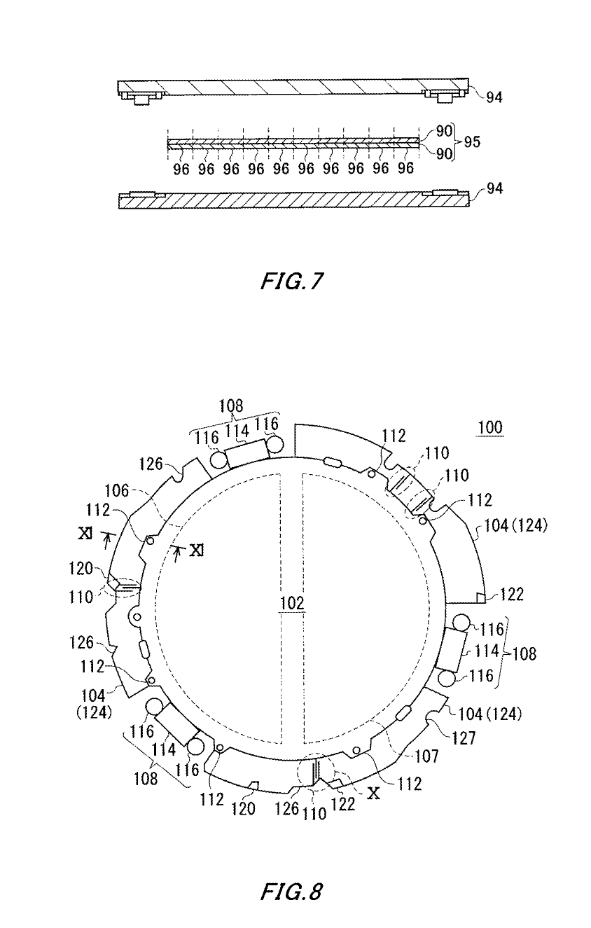

Next, the load lock chamber 48 is opened to the atmosphere, and then the access door 50 is opened. In this state, the robot arm 30 transports the bonded substrate 95 from the load lock chamber 48 to the movable stage 38. As shown in FIG. 7, the bonded substrate 95 is separated from the substrate holder 94 by the robot arm 30 on the movable stage 38. After this, the robot arm 24 transports the bonded substrate 95 to one of the substrate cassettes 20. In this way, the bonding process performed by the substrate bonding apparatus 10 is ended and the bonded substrate 95 is completed. After this, in the dicing step, the bonded substrate 95 is cut along the dotted lines shown in FIG. 7 to complete the layered semiconductor apparatus 96.

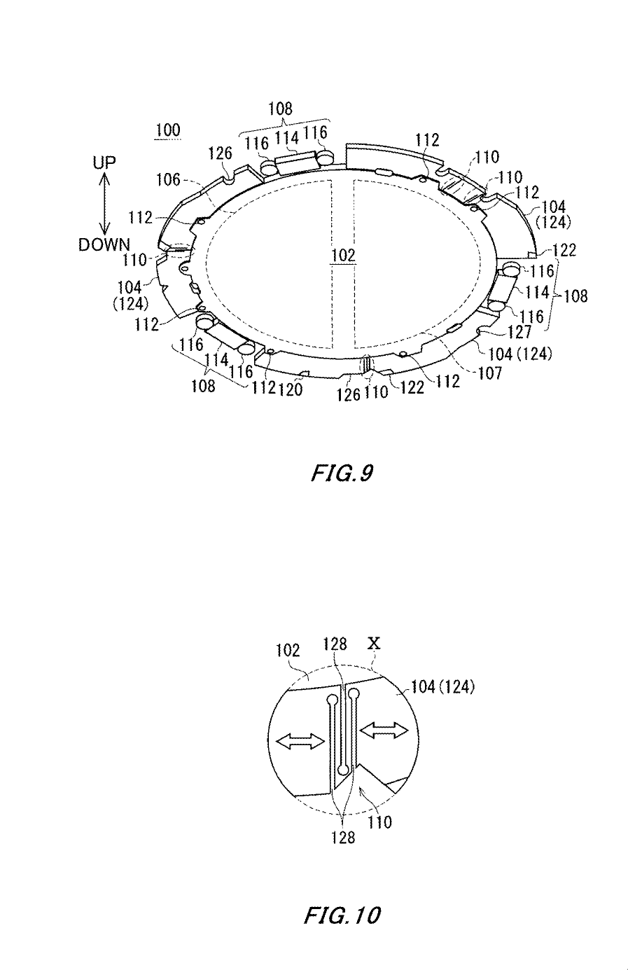

FIG. 8 is a bottom view of the upper substrate holder 100, which is one of the substrate holders 94. FIG. 9 is a perspective view of the upper substrate holder 100 as seen from above. The up and down arrows shown in FIG. 9 are the up and down directions. As shown in FIGS. 8 and 9, the upper substrate holder 100 includes an upper mounting portion 102, an upper ear portion 104, a pair of upper electrode pads 106 and 107, three adhering units 108, upper power supply terminals 120 and 122, a plurality of upper absorbing portions 110, and a plurality of upper connecting portions 112. The upper absorbing portions 110 and the upper connecting portions 112 are examples of a restricting section and an absorbing section, and the upper ear portion 104 is an example of a supported section.

The upper mounting portion 102 has a stress tolerance of 120 MPa, and is formed of MN with a thermal expansion coefficient of 4.5×10⁻⁶. The MN is an example of a ceramic. The upper mounting portion 102 is formed to be substantially disc shaped and larger than the substrate 90. The bottom surface of the upper mounting portion 102 is formed to be flat. The bottom surface of the upper mounting portion 102 extends farther downward than the upper ear portion 104. The central portion of the bottom surface of the upper mounting portion 102 functions as a mounting surface on which the substrate 90 is mounted.

The upper ear portion 104 is supported by the robot arms 24, 30, 54, 58, etc. during transport. The upper ear portion 104 is shaped as a ring. The upper ear portion 104 is separated into three upper ear pieces 124 along the circumferential direction. The upper ear pieces 124 are distanced from each other in the circumferential direction. In other words, there are spaces between the adjacent upper ear pieces 124. The inner circumference of the upper ear portion 104 has substantially the same shape as the outer circumference of the upper mounting portion 102. The inner circumference of the upper ear portion 104 is connected to the outer circumferential edge of the upper mounting portion 102 by the plurality of upper connecting portions 112. The upper ear portion 104 may be supported by other members such as pins of a temporary stage, instead of or in addition to the robot arm 24.

A plurality of notches 126 are formed in the outer circumference of the upper ear portion 104. The notches 126 have a plurality of functions. For example, the notches 126 allow pressing pins to pass therethrough in order to separate the upper substrate holder 100 and the lower substrate holder described further below. The edges of the notches 126 are machined using a high-temperature laser. In this way, after the pressuring is performed and the upper substrate holder 100 returns to a normal temperature, compression stress acts on the edges of the notches 126. As a result, warping caused by deformation due to the compression stress is absorbed by the notches 126, and damage to the upper ear portion 104 can be restricted. Furthermore, a dummy notch 127 may be formed in the periphery of the upper ear portion 104. The dummy notch 127 is preferably more curved than the notches 126 and preferably a larger opening than the notches 126. In this way, the dummy notch 127 can absorb compression stress and restrict deformation of the notches 126 due to stress.

The upper electrode pad 106 is formed as a semicircle. The upper electrode pads 106 and 107 are buried within the upper mounting portion 102. The upper electrode pad 106 is arranged with linear symmetry relative to the upper electrode pad 107, in a manner to sandwich the center of the upper mounting portion 102. The upper power supply terminals 120 and 122 are provided in the periphery of the upper ear portion 104. The upper power supply terminals 120 and 122 are arranged on both the top and bottom surface of the upper ear portion 104. The upper power supply terminals 120 and 122 are electrically connected to the robot arms 24, 30, 54, 58, etc. during transport, to be provided with power. The upper power supply terminal 120 supplies power to the upper electrode pad 106 to charge the upper electrode pad 106 with a positive charge. The upper power supply terminal 122 provides power to the upper electrode pad 107 to charge the upper electrode pad 107 with a negative charge. In this way, the upper electrode pad 106 generates electrostatic power to adhere the substrate 90 using electrostatic adhesion.

The three adhering units 108 are arranged on the peripheral side of the upper mounting portion 102 at locations where the upper ear portion 104 is cut away. The three adhering units 108 are arranged at intervals of substantially 120 degrees in the circumferential direction. The adhering units 108 each include an upper connecting member 114 and a pair of adhesion members 116. In a planar view, each upper connecting member 114 is substantially rectangular and long in the circumferential direction of the upper mounting portion 102. The inner circumference of the upper connecting member 114 is connected to the outer circumference of the upper mounting portion 102. The pair of adhesion members 116 is provided at the ends of the upper connecting member 114. The pair of adhesion members 116 include permanent magnets.

FIG. 10 is an enlarged planar view of the region near the upper absorbing portion 110 surrounded by the dotted line X in FIG. 8. As shown in FIG. 10, the upper absorbing portions 110 are formed at a plurality of locations on the upper ear portion 104 in the circumferential direction. A plurality of slits 128 are formed in the upper absorbing portions 110 to allow for relative misalignment caused by a difference in the thermal expansion amount between the upper mounting portion 102 and the upper ear portion 104. Two upper connecting portions 112 are provided for one upper ear portion 104, and one upper absorbing portion 110 is arranged between the two upper connecting portions 112. In this way, the difference in contraction and expansion due to heat can be more reliably absorbed.

Each slit 128 passes through the upper ear portion 104 in a vertical direction. The tip of each slit 128 is formed to be circular to mitigate the stress. In each upper absorbing portion 110, a slit 128 that extends radially from the outer circumference side of the upper ear portion 104 and a slit 128 that extends radially from the inner circumference side of the upper ear portion 104 are formed in an alternating manner. When the upper ear portion 104 expands and contracts in the direction shown by the arrow, the upper absorbing portion 110 expands and contracts in the circumferential direction, thereby restricting damage to the upper ear portion 104.

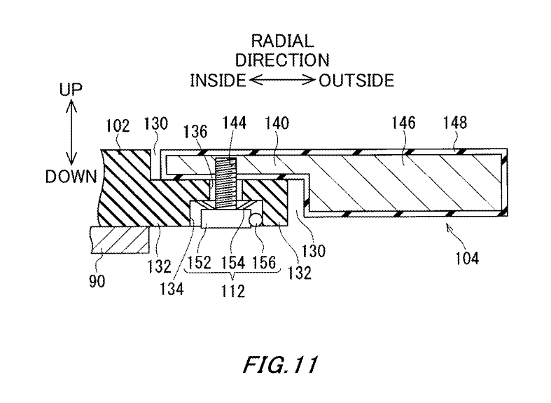

FIG. 11 is a vertical cross-sectional view along the line X1-X1 of FIG. 8, and is used to describe an exemplary upper connecting portion 112. As shown in FIG. 11, a gap 130 is formed in the radial direction between the outer circumferential surface of the upper mounting portion 102 and the inner circumferential surface of the upper ear portion 104. The gap 130 is an example of an absorbing section that absorbs a difference in the thermal expansion amount between the upper mounting portion 102 and the upper ear portion 104, and is also a restricting section that restricts damage by absorbing the difference in the thermal expansion coefficient.

An outer circumferential groove 132 is formed below the outer circumferential portion of the upper mounting portion 102. The outer circumferential groove 132 is formed through the entire outer circumferential portion of the upper mounting portion 102. A large-diameter portion 134 and a small-diameter portion 136 are formed in the outer circumferential groove 132. The large-diameter portion 134 and the small-diameter portion 136 are cylindrical holes. The center of the large-diameter portion 134 and the center of the small-diameter portion 136 are matching. The large-diameter portion 134 is formed below the small-diameter portion 136. The bottom plane of the large-diameter portion 134 is open. The top plane of the small-diameter portion 136 is open. The large-diameter portion 134 and the small-diameter portion 136 are connected. Accordingly, a stepped portion is formed where the large-diameter portion 134 and the small-diameter portion 136 connect.

An inner circumferential groove 140 that supports the outer circumferential edge of the upper mounting portion 102 is formed above the inner circumferential portion of the upper ear portion 104. The inner circumferential groove 140 is formed across the entire inner circumference of the upper ear portion 104. The bottom surface of the inner circumferential groove 140 contacts the top surface of the outer circumferential groove 132. A bolt hole 144 is formed in the inner circumferential groove 140. The bolt hole 144 is open at the bottom. The bolt hole 144 is formed at a position opposite the small-diameter portion 136. In this way, the bolt hole 144 is connected to the small-diameter portion 136. A gap is formed between the inner circumferential surface of the upper ear portion 104 and the outer circumferential surface of the upper mounting portion 102. In this way, the upper ear portion 104 and the upper substrate holder 100 can expand, contract, and move in the radial direction relative to each other.

The upper ear portion 104 has a frame 146 made of Ti-6Al-4V, which is an example of a conductive metal, and a ceramic film 148 made of Al₂O₃. The stress tolerance of the Ti-6Al-4V forming the frame 146 is 460 MPa, which is greater than the stress tolerance of the upper mounting portion 102. The thermal expansion coefficient of the Ti-6Al-4V forming the frame 146 is 8.8×10⁻⁶/° C., which is greater than the thermal expansion coefficient of the upper mounting portion 102. The ceramic film 148 is formed over the entire surface of the frame 146. The ceramic film 148 is formed by performing ceramic spray coating on the frame 146, for example.

The upper connecting portion 112 is biased to make the upper mounting portion 102 movable in the radial direction relative to the upper ear portion 104, and elastically connects the upper mounting portion 102 and the upper ear portion 104. The upper connecting portion 112 includes a ceramic connecting bolt 152, a plate spring washer 154, and a locking member 156.

The connecting bolt 152 is screwed into the bolt hole 144. The diameter of the head portion of the connecting bolt 152 is less than the diameter of the large-diameter portion 134, and greater than the diameter of the small-diameter portion 136. Accordingly, the head of the connecting bolt 152 can be inserted into the large-diameter portion 134, but cannot be inserted into the small-diameter portion 136. Furthermore, a gap is formed between the connecting bolt 152 and the large-diameter portion 134 and the small-diameter portion. In this way, the upper mounting portion 102 can move in the radial direction relative to the upper ear portion 104.

The plate spring washer 154 is formed by a material capable of elastic deformation. The plate spring washer 154 is formed as a hollow partial cone. The plate spring washer 154 is provided between the top surface of the head of the connecting bolt 152 and the top plane of the large-diameter portion 134. In this way, the plate spring washer 154 transmits the pressing force of the connecting bolt 152 to the upper mounting portion 102. As a result, the upper mounting portion 102 is sandwiched between the connecting bolt 152 and the upper ear portion 104, via the plate spring washer 154. In this state, the bottom surface of the upper mounting portion 102 is positioned lower than the bottom surface of the upper ear portion 104.

The locking member 156 is provided between the head of the connecting bolt 152 and the side wall of the large-diameter portion 134. The locking member 156 is an elastic body such as an adhesive that is heat resistant. The locking member 156 is an elastic body, and therefore locks the pivoting of the connecting bolt 152 while not obstructing the movement of the connecting bolt 152 in a direction along the mounting surface.

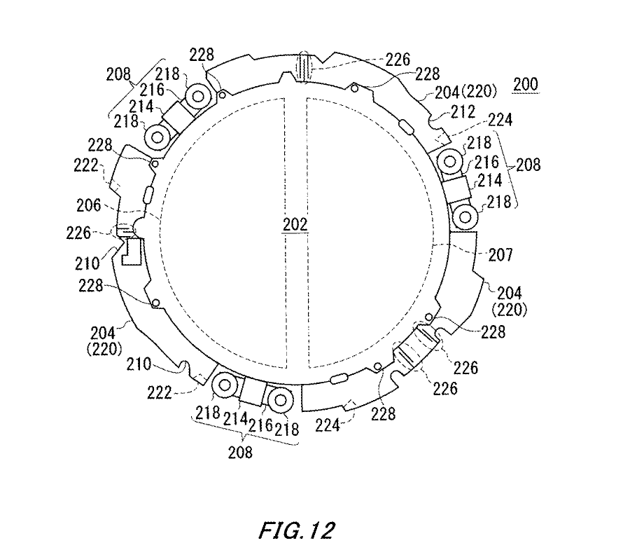

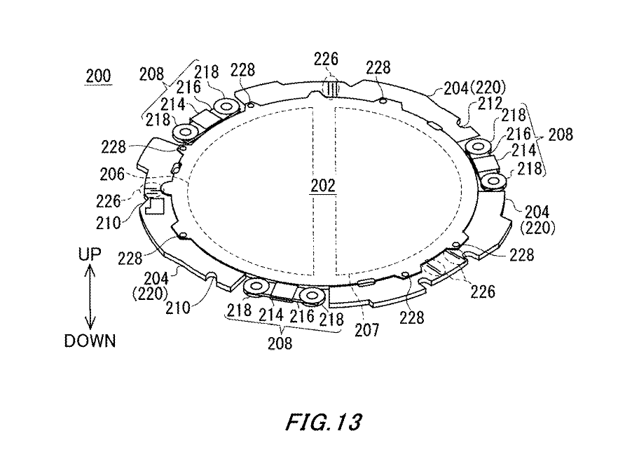

FIG. 12 is a top view of the lower substrate holder 200, which is the other substrate holder 94. FIG. 13 is a perspective view of the lower substrate holder 200 as seen from above. The up and down arrows in FIG. 13 indicate the up and down directions. As shown in FIGS. 12 and 13, the lower substrate holder 200 includes a lower mounting portion 202, a lower ear portion 204, a pair of lower electrode pads 206 and 207, three adhered portions 208, lower power supply terminals 222 and 224, a lower suction portion 226, and a lower connecting portion 228. The lower ear portion 204 is an exampled of a supported section, in the same manner as the upper ear portion 104.

The lower mounting portion 202 is formed with a substantially disc shape that is larger than the substrate 90. The top surface of the lower mounting portion 202 is formed to be flat. The top surface of the lower mounting portion 202 protrudes above the lower ear portion 204. The top surface of the center portion of the lower mounting portion 202 functions as the mounting surface on which the substrate 90 is mounted.

The lower ear portion 204 is supported by the robot arms 24, 30, 54, 58, etc. during transport. The lower ear portion 204 is formed with a ring shape. The lower ear portion 204 is separated into three lower ear pieces 220 along the circumferential direction. The lower ear pieces 220 are distanced from each other in the circumferential direction. The inner circumference of the lower ear portion 204 forms substantially the same shape as the outer circumference of the lower mounting portion 202. The inner circumference of the lower ear portion 204 is fixed to the outer circumference of the lower mounting portion 202. Notches 210 and a dummy notch 212 are formed in the outer circumference of the lower ear portion 204, to function in the same manner as the notches 126 and the dummy notch 127.

The lower electrode pad 206 is formed as a semicircle. The lower electrode pads 206 and 207 are buried within the lower mounting portion 202. The lower electrode pad 206 is positioned with linear symmetry relative to the lower electrode pad 207, in order to sandwich the center of the lower mounting portion 202. The lower power supply terminals 222 and 224 are formed on the bottom surface of the lower ear portion 204. The lower electrode pad 206 is charged with a negative charge by the power supplied from the lower power supply terminal 222. The lower electrode pad 207 is charged with a positive charge from the lower power supply terminal 224. In this way, the lower electrode pad 206 generates electrostatic force to electrostatically adhere the substrate 90 thereto.

The three adhered portions 208 are arranged in the outer circumferential side of the lower mounting portion 202, at locations where the lower ear portion 204 is separated. The three adhered portions 208 are arranged at intervals of substantially 120° in the circumferential direction. Each adhered portion 208 includes a lower connecting member 214, a lower elastic member 216, and a pair of adhered members 218.

The lower connecting member 214 is formed with a substantially square shape, when viewed flat. The inner ends of the lower connecting member 214 are connected to the outer circumference of the lower mounting portion 202. The lower elastic member 216 is formed by a material capable of elastic deformation. The lower elastic member 216 is formed as a rectangle that is long in the circumferential direction. The center of the lower elastic member 216 is connected to the lower connecting member 214. The adhered member 218 includes a material that adheres to a magnet, e.g. a ferromagnetic material. The pair of adhered members 218 is arranged at both ends of the bottom surface of the lower elastic member 216. The pair of adhered members 218 is arranged facing the adhesion member 116. As a result, when the bottom surface of the upper substrate holder 100 and the top surface of the lower substrate holder 200 are brought near while facing each other, the adhered member 218 is adhered to the adhesion member 116 by magnetic force. As a result, the substrates 90 are held by the upper substrate holder 100 and the lower substrate holder 200. With the substrate being held, the lower elastic member 216 elastically deforms to suitably adjust the pressing force acting on the substrates 90 from the upper substrate holder 100 and the lower substrate holder 200.

The lower suction portion 226 and the lower connecting portion 228 have substantially the same configuration as the upper absorbing portion 110 and the upper connecting portion 112. In a state where the upper substrate holder 100 and lower substrate holder 200 face each other and the substrates 90 are held, the lower connecting portion 228 is positioned facing the upper connecting portion 112.

The following describes a case in which the upper substrate holder 100 and lower substrate holder 200 are heated to expand and contract. For example, when the upper substrate holder 100 and the lower substrate holder 200 are heated by the thermocompression apparatus 56, the upper substrate holder 100 and the lower substrate holder 200 expand. However, since the material forming the upper mounting portion 102 and the material forming the upper ear portion 104 are different in the upper substrate holder 100, the stress tolerance and expansion amount are different. The upper absorbing portion 110 is formed on the upper ear portion 104, which has higher stress tolerance and a greater expansion amount than the upper mounting portion 102. In the upper ear portion 104 having greater expansion, the upper absorbing portion 110 deforms in the circumferential direction to absorb this expansion. In this way, the upper absorbing portion 110 absorbs and reduces the difference in thermal expansion amount between the upper mounting portion 102 and the upper ear portion 104. As a result, the slit 128 in the upper absorbing portion 110 allows for the relative positional skew between the upper mounting portion 102 and the upper ear portion 104 caused by the difference in thermal expansion amount between the upper mounting portion 102 and the upper ear portion 104. Furthermore, since the upper ear portion 104 has high stress tolerance, the upper ear portion 104 is not damaged by the deformation of the upper absorbing portion 110 in the circumferential direction. As a result, damage to the upper substrate holder 100 can be restricted.

A gap is formed between the connecting bolt 152 and the large-diameter portion 134 and small-diameter portion 136. Furthermore, a gap 130 is formed between the inner circumferential surface of the upper ear portion 104 and the outer circumferential surface of the upper mounting portion 102. In this way, when the inner circumferential groove 140 expands near the upper connecting portion 112, the plate spring washer 154 slides along the top plane of the large-diameter portion 134 and the inner circumferential groove 140 moves relative to the outer circumferential groove 132. As a result, the upper connecting portion 112 and the gap 130 absorb the thermal expansion of the upper ear portion 104 and can restrict damage to the upper substrate holder 100.

The thermal expansion coefficient of the upper ear portion 104 is greater than the thermal expansion coefficient of the upper mounting portion 102. Therefore, the difference in thermal expansion amount between the upper ear portion 104 and the upper mounting portion 102, which is heated more than the upper ear portion 104 by the thermocompression apparatus 56 and reaches a higher temperature, can be reduced.

In the step of bonding by the thermocompression apparatus 56, the upper ear portion 104 is preferably blown with nitrogen in the cooling room 60. In this case, the outside of the upper mounting portion 102 is preferably covered by a pressing machine or the like. In this way, the inside of the upper mounting portion 102 is covered by the substrate 90 and the outside is covered by the pressing machine, so that the nitrogen does not directly reach the upper mounting portion 102, thereby enabling a decrease of the difference in thermal expansion amount. The lower substrate holder 200 has the same structure, and therefore can realize the same effect.

The following describes an embodiment in which a portion of the upper substrate holder 100 and the lower substrate holder 200 described above has been altered.

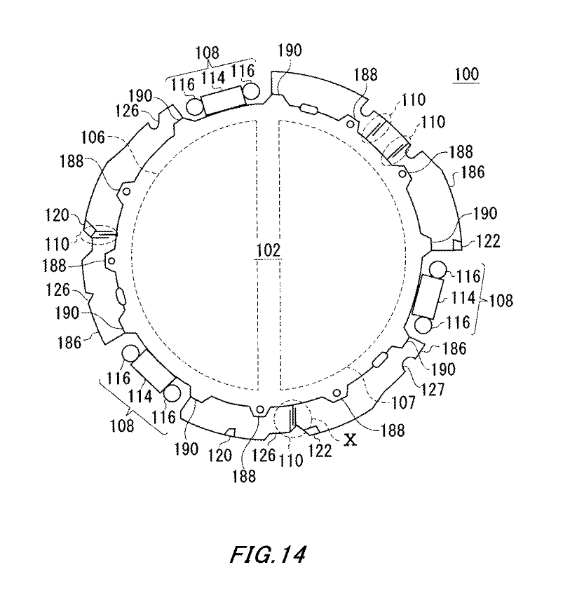

FIG. 14 is a top view of the altered upper substrate holder 100. In FIG. 14, components that are the same as components in FIG. 8 are given the same reference numerals, and redundant descriptions are omitted. The upper substrate holder 100 of FIG. 14 includes the upper mounting portion 102, an upper ear portion 186 separated into three pieces, and three adhering units 108. Each of the three pieces of the upper ear portion 186 has two upper fastening portions 188 and two upper locking portions 190 on the inner circumference thereof. The two upper locking portions 190 are provided outside of the two upper fastening portions 188 in the circumferential direction to sandwich the upper fastening portions 188. The upper ear portions 186 are connected to the outer circumference of the upper mounting portion 102 by the two upper fastening portions 188, and are locked in the direction perpendicular to the mounting surface of the upper mounting portion 102 by the two upper locking portions 190.

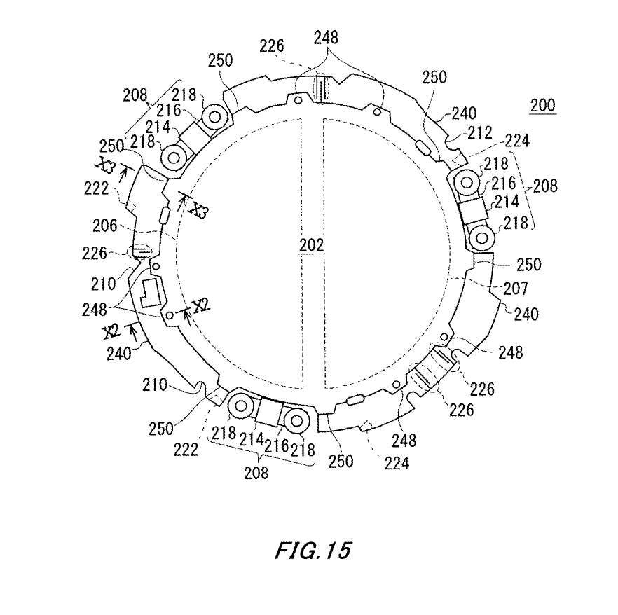

FIG. 15 is a top view of the lower substrate holder 200 with an altered portion corresponding to the upper substrate holder 100 of FIG. 14. In FIG. 15, components that are the same as components in FIG. 12 are given the same reference numerals, and redundant descriptions are omitted. As shown in FIG. 15, the lower substrate holder 200 includes the lower mounting portion 202, a lower ear portion 240 separated into three pieces, and three adhered portions 208. Each of the three pieces of the lower ear portion 240 has two lower fastening portions 248 and two lower locking portions 250 on the inner circumference thereof. The two lower locking portions 250 are provided outside of the two lower fastening portions 248 in the circumferential direction to sandwich the lower fastening portions 248. The lower fastening portions 248 have a structure that is identical to vertical inversion of the upper fastening portions 188, and therefore the lower fastening portions 248 are used for the description and a description of the upper fastening portions 188 is omitted. Furthermore, the lower locking portions 250 have a structure that is identical to vertical inversion of the upper locking portions 190, and therefore the lower locking portions 250 are used for the description and a description of the upper locking portions 190 is omitted.

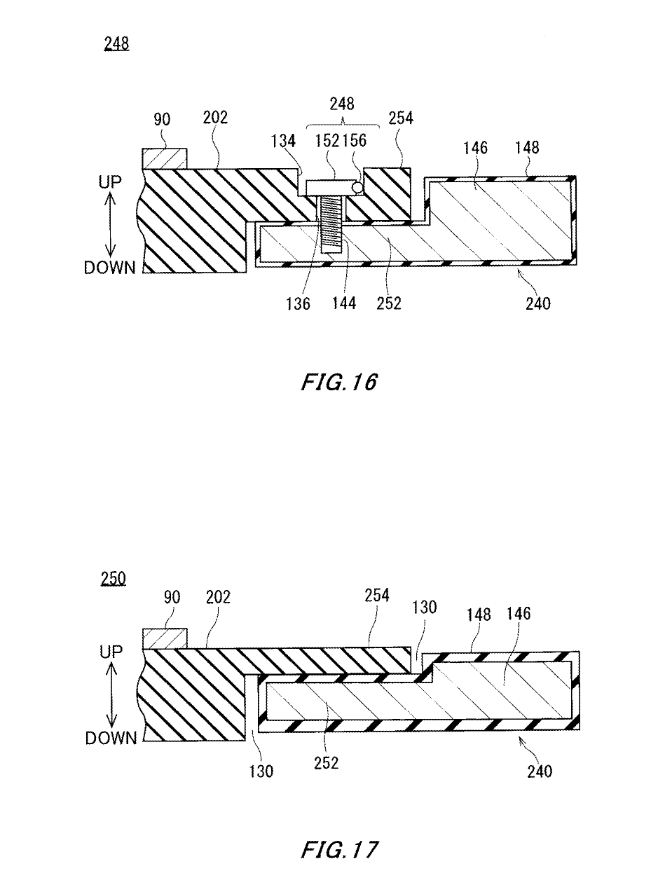

FIG. 16 is a vertical cross-sectional view of an exemplary lower fastening portion 248 along the line X2-X2 shown in FIG. 15. In FIG. 16, components that are the same as components in FIG. 11 are given the same reference numerals, and redundant descriptions are omitted. As shown in FIG. 16, an outer circumferential groove 254 is formed on the top of the outer circumferential portion of the lower mounting portion 202. The outer circumferential groove 254 is a hole formed by the large-diameter portion 134 and the small-diameter portion 136. An inner circumferential groove 252 is formed below the inner circumference of the lower ear portion 240. A bolt hole 144 is formed in the inner circumferential groove 252. In the present embodiment, the connecting bolt 152 directly contacts the stepped portion of the large-diameter portion 134 and the small-diameter portion 136, and screws into the bolt hole 144 formed in the lower ear portion 240. The lower fastening portion 248 fastens the lower mounting portion 202 and the lower ear portion 240 in a manner to prevent movement in a direction along the mounting surface and a direction perpendicular to the mounting surface of the lower mounting portion 202 on which the substrate is mounted.

FIG. 17 is a vertical cross-sectional view of an exemplary lower locking portion 250 along the line X3-X3 shown in FIG. 15. In FIG. 17, components that are the same as components in other drawings are given the same reference numerals, and redundant descriptions are omitted. As shown in FIG. 17, in the lower locking portion 250, the inner circumferential groove 252 of the lower ear portion 240 enters into and is locked below the outer circumferential groove 254 of the lower mounting portion 202 in a direction perpendicular to the mounting surface of As described above, the lower ear portion 240 is supported by the robot arms 24, 30, 54, 58, etc. during transport. The lower ear portion 240 supported by the robot arms 24, 30, 54, 58, etc. has the lower mounting portion 202 thereof supported by the two lower fastening portions 248 and two lower locking portions 250. The lower locking portion 250 has a gap 130 that is greater than the thermal expansion of the lower ear portion 240 in the direction along the mounting surface. The lower ear portion 240 can absorb the thermal expansion by sliding relative to the mounting surface. On the other hand, has the top surface of the inner circumferential groove 252 in contact with the bottom surface of the outer circumferential groove 254, and therefore movement of the lower locking portion 250 relative to the mounting surface is restricted in the direction perpendicular to the mounting surface.

The lower ear portion 240 supported by the robot arms 24, 30, 54, 58, etc. can be supported at four locations on the lower mounting portion 202, which are the two lower fastening portions 248 and the two lower locking portions 250. Since the lower ear portion 240 can have the lower mounting portion 202 supported at four locations, the warping of the outer circumferential groove 254 of the lower mounting portion 202 and the inner circumferential groove 252 of the lower ear portion 240 can be restricted. As a result, the lower mounting portion 202 can be maintained at the correct position to hold the substrate 90. Furthermore, since the lower locking portion 250 is provided outside the lower fastening portion 248 in the circumferential direction, even when the lower ear portion 240 expands due to heat, the inner circumferential groove 252 can slide outward in the circumferential direction along the mounting surface, thereby absorbing the thermal expansion. In this way, in the lower substrate holder 200 including the lower fastening portion 248 and the lower locking portion 250, the outer circumferential groove 254 and the inner circumferential groove 252 can be prevented from warping when being transported by the robot arms, thereby restricting damage to the lower ear portion 240 caused by thermal expansion.

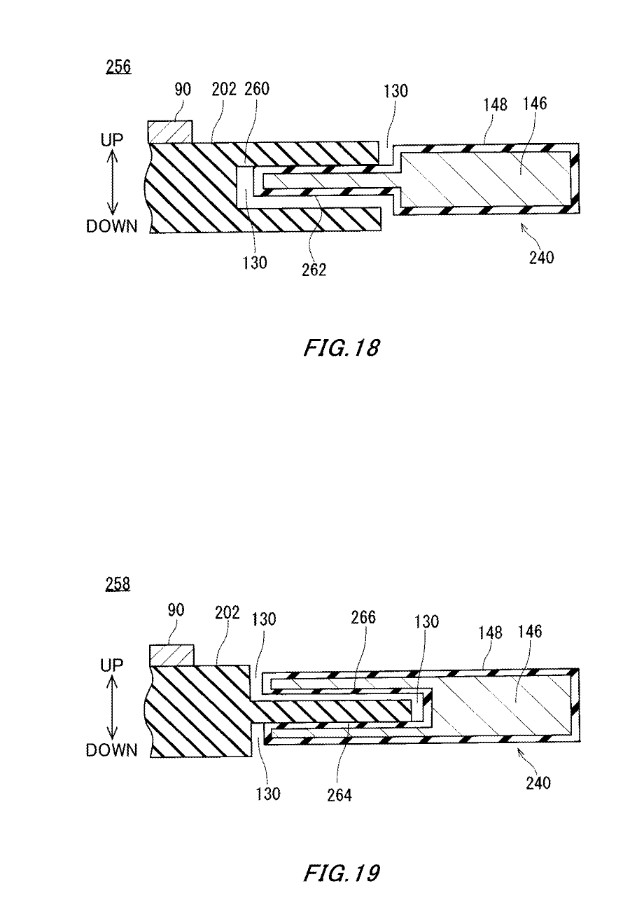

FIG. 18 is a vertical cross-sectional view of another exemplary lower locking portion 256 along the line X3-X3 shown in FIG. 15. In FIG. 18, components that are the same as components in other drawings are given the same reference numerals, and redundant descriptions are omitted. As shown in FIG. 18, the outer circumference of the lower mounting portion 202 forming the lower locking portion 256 has a recess 260 in the center thereof in a direction perpendicular to the mounting surface. On the other hand, the inner circumference of the lower ear portion 240 has a protrusion 262 that protrudes from the center thereof in a direction perpendicular to the mounting surface, and this recess 260 and protrusion 262 have complementary shapes.

The protrusion 262 of the lower ear portion 240 enters into and becomes locked by the recess 260 at the center portion of the lower mounting portion 202, relative to the direction perpendicular to the mounting surface. Since the lower ear portion 240 includes the gap 130, the lower ear portion 240 can slide relative to the mounting surface in a direction along the mounting surface. On the other hand, since the lower ear portion 240 has the top surface of the protrusion 262 contacting the bottom surface of the protrusion at the upper portion of the recess 260, the movement of the lower ear portion 240 relative to the mounting surface is restricted in the direction perpendicular to the mounting surface. In this way, the lower ear portion 240 can be supported at four locations on the lower mounting portion 202, including the two lower fastening portions 248 and the two lower locking portions 256. Accordingly, the lower substrate holder 200 including the lower fastening portions 248 and the lower locking portions 256 can achieve the same effect as the lower substrate holder 200 including the lower locking portions 250.

FIG. 19 is a vertical cross-sectional view of another exemplary lower locking portion 258 along the line X3-X3 shown in FIG. 15. In FIG. 19, components that are the same as components in other drawings are given the same reference numerals, and redundant descriptions are omitted. As shown in FIG. 19, the outer circumference of the lower mounting portion 202 forming the lower locking portion 258 has a protrusion 264 that protrudes from the center in the direction perpendicular to the mounting surface. On the other hand, the inner circumference of the lower ear portion 240 has a recess 266 in the center thereof that is recessed in the direction perpendicular to the mounting surface. The protrusion 264 of the lower mounting portion 202 enters into and is locked by the center of the recess 260 of the lower ear portion 240, in the direction perpendicular to the mounting surface. In other words, the shapes of the lower ear portion 240 and the lower mounting portion 202 are opposite with respect to the lower locking portion 256. The lower substrate holder 200 including such a lower locking portion 258 can realize the same effect as the lower substrate holder 200 including the lower locking portion 250.

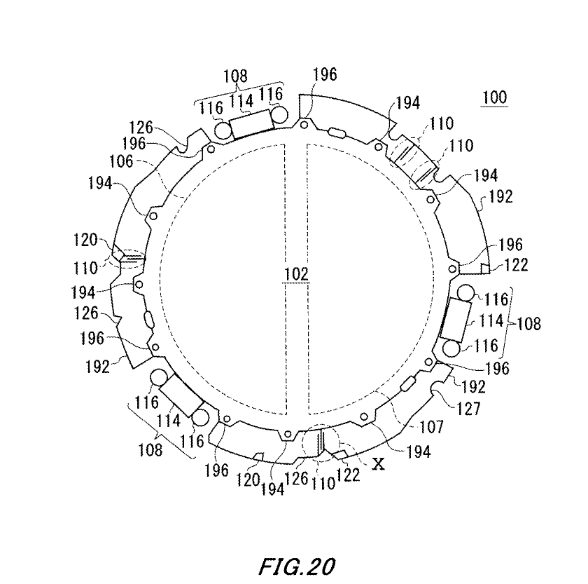

The following describes an embodiment obtained by further altering a portion of the upper substrate holder 100 and the lower substrate holder 200 described above. FIG. 20 is a bottom view of the altered upper substrate holder 100. In FIG. 20, components that are the same as components in other drawings are given the same reference numerals, and redundant descriptions are omitted. As shown in FIG. 20, the altered upper substrate holder 100 includes an upper mounting portion 102, an upper ear portion 192 separated into three pieces, and three adhering units 108. Each of the separated three upper ear portions 192 has its inner circumference connected to the upper mounting portion 102 at four locations, including two inside upper fastening portions 194 and two upper sliding connection portions 196 that are outward in the circumferential direction. The upper fastening portions 194 have the same configuration as the upper fastening portion 188, and so the description thereof is omitted.

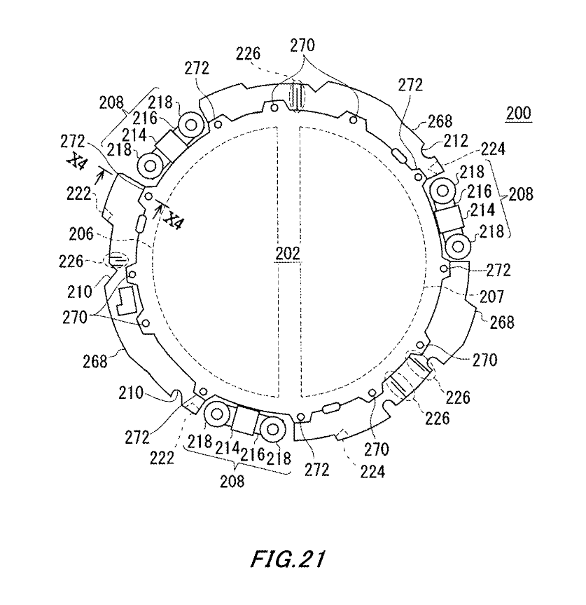

FIG. 21 is a top view of the altered lower substrate holder 200 corresponding to the upper substrate holder 100 of FIG. 20. In FIG. 21, components that are the same as components in other drawings are given the same reference numerals, and redundant descriptions are omitted. As shown in FIG. 21, the altered lower substrate holder 200 includes a lower mounting portion 202, a lower ear portion 268 separated into three pieces, and three adhered portions 208. Each of the separated three lower ear portions 268 has its inner circumference connected to the lower mounting portion 202 at four locations, including two inner lower fastening portions 270 and two lower sliding connection portions 272 that are outward in the circumferential direction. The lower fastening portions 270 have the same configuration as the lower fastening portion 248, and so the description thereof is omitted. Furthermore, the lower sliding connection portions 272 have a structure that is the vertical inverse of the structure of the upper sliding connection portions 196, and therefore the description uses the lower sliding connection portions 272 and description of the upper sliding connection portions 196 is omitted.

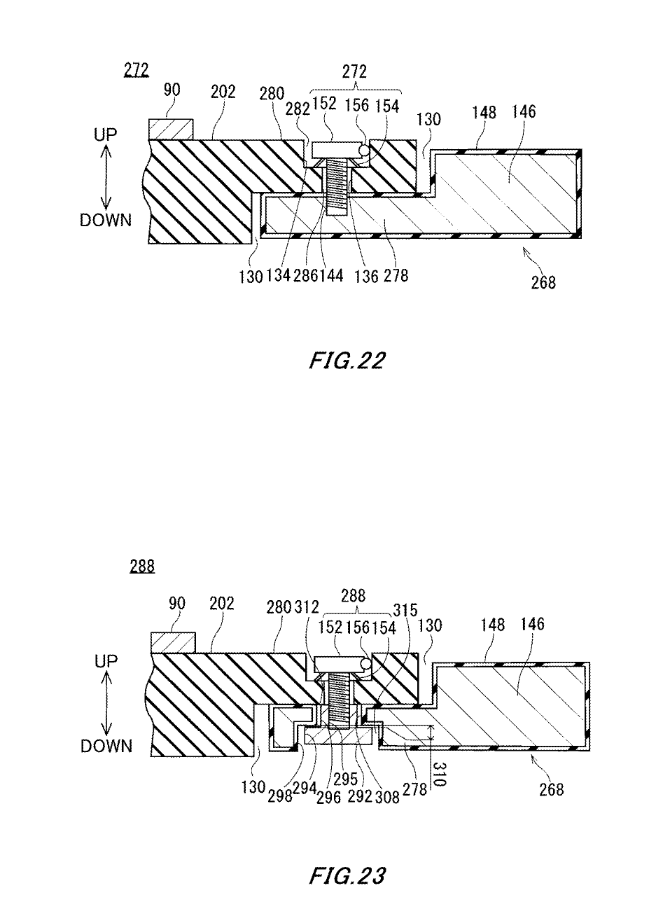

FIG. 22 is a vertical cross-sectional view of an exemplary lower sliding connection portion 272 along the line X4-X4 shown in FIG. 21. In FIG. 22, components that are the same as components in other drawings are given the same reference numerals, and redundant descriptions are omitted. An outer circumferential groove 280 is formed on the top of the outer circumferential portion of the lower mounting portion 202. A hole made by a large-diameter portion 134 and a small-diameter portion 136 is formed in the outer circumferential groove 280. An inner circumferential groove 278 is formed in the bottom of the inner circumference of the lower ear portion 268. A bolt hole 144 is formed in the inner circumferential groove 278. As shown in FIG. 22, a gap 130 is formed between the outer circumferential surface of the lower mounting portion 202 and the inner circumferential surface of the lower ear portion 268.

The lower sliding connection portion 272 biases the lower ear portion 268 is a manner to be movable toward the lower mounting portion 202 in the radial direction, and elastically connects the lower mounting portion 202 and the lower ear portion 268. The lower sliding connection portion 272 includes a ceramic connecting bolt 152, a plate spring washer 154, and a locking member 156.

The connecting bolt 152 screws into the bolt hole 144. A gap 282 is formed between the connecting bolt 152 and the large-diameter portion 134. The plate spring washer 154 is formed between the bottom surface of the head of the connecting bolt 152 and the bottom surface of the large-diameter portion 134. In this way, the plate spring washer 154 transmits the pressing force of the connecting bolt 152 to the upper mounting portion 102. As a result, the lower ear portion 268 and the lower mounting portion 202 are connected in the direction perpendicular to the mounting surface, via the plate spring washer 154.

A gap 286 is formed between the connecting bolt 152 and the small-diameter portion 136. The sizes of the gap 282, the gap 286, and the gap 130 between the inner circumferential surface of the lower ear portion 268 and the outer circumferential surface of the upper mounting portion 102 are greater than the thermal expansion of the lower ear portion 240. These gaps enable the lower ear portion 268 to slide relative to the mounting surface, in a direction along the mounting surface, against the bias force of the plate spring washer 154.

The lower ear portion 268 can be supported at four locations on the lower mounting portion 202, including the two lower fastening portions 270 and the two lower sliding connection portions 272, and therefore can restrict warping of the outer circumferential groove 280 of the lower mounting portion 202 and the inner circumferential groove 278 of the lower ear portion 268. As a result, the lower mounting portion 202 can keep the substrate 90 at the correct holding position. Furthermore, since the lower sliding connection portion 272 is provided on the outside of the lower fastening portion 270 in the circumferential direction, the lower ear portion 268 can absorb the thermal expansion by having the inner circumferential groove 252 slide outward in the circumferential direction along the mounting surface. In this way, the lower substrate holder 200 including the lower fastening portion 270 and the lower sliding connection portion 272 can restrict warping of the outer circumferential groove 280 and the inner circumferential groove 278 during transport by the robot arm, and can restrict damage caused by thermal expansion of the lower ear portion 268.

FIG. 23 is a vertical cross-sectional view of another lower sliding connection portion 288 along the line X4-X4 shown in FIG. 21. In FIG. 23, components that are the same as components in other drawings are given the same reference numerals, and redundant descriptions are omitted. As shown in FIG. 23, the lower sliding connection portion 288 includes a connecting bolt 152, a nut plate 292, a plate spring washer 154, and a locking member 156. The nut plate 292 includes a large-diameter portion 294, a bolt hole 295, and a small-diameter portion 296. By inserting the connecting bolt 152 into the small-diameter portion 136 of the outer circumferential groove 280 of the lower mounting portion 202 and screwing the connecting bolt 152 into the bolt hole 295, the connecting bolt 152 and the nut plate 292 are connected to the outer circumferential groove 280. An inner circumferential groove 278 is formed on the bottom of the inner circumference of the lower ear portion 268. A hole formed by a large-diameter portion 298 and a small-diameter portion 308 is formed in the same central position of the inner circumferential groove 278. By fastening the small-diameter portion 296 of the nut plate 292 inserted into the small-diameter portion 308 and the connecting bolt 152 inserted into the small-diameter portion 136 of the lower mounting portion 202, the small-diameter portion 308 of the inner circumferential groove 278 is interposed between the lower mounting portion 202 and the large-diameter portion 294 of the nut plate 292. In this way, the lower mounting portion 202 and the lower ear portion 268 are connected.

The length of the small-diameter portion 296 of the nut plate 292 in the up and down direction is slightly greater than the length of the small-diameter portion 308 of the inner circumferential groove 278 in the up and down direction, and therefore there is a small gap 310 between the top plane of the large-diameter portion 294 of the nut plate 292 and the bottom plane of the small-diameter portion 308 of the inner circumferential groove 278. The gap 310 is an example of a gutter. The diameter of the small-diameter portion 296 of the nut plate 292 is smaller than the diameter of the small-diameter portion 308 of the inner circumferential groove 278, and there is a gap 312 between these. The diameter of the large-diameter portion 294 of the nut plate 292 is smaller than the diameter of the large-diameter portion 298 of the inner circumferential groove 278, and there is a gap 315 between these. A gap 130 is formed between the outer circumferential surface of the lower mounting portion and the inner circumferential surface of the lower ear portion 268. The sizes of the gap 312, the gap 315, and the gap 130 are greater than the thermal expansion of the lower ear portion 268.

There is a very small gap 310 in the up and down direction between the large-diameter portion 294 of the nut plate 292 fixed to the lower mounting portion 202 and the small-diameter portion 308 of the inner circumferential groove 278. There are gaps 312, 315, and 130 between the lower mounting portion 202 and the lower ear portion 268 in the circumferential direction. These gaps unable the lower ear portion 268 to slide relative to the mounting surface, along the direction of the mounting surface, but prevent movement in the up and down direction.

By including the lower sliding connection portion 288, the even when the lower ear portion 268 expands due to heat, the inner circumferential groove 278 can absorb this thermal expansion by sliding outward in the circumferential direction along the mounting surface. In this way, by providing the lower sliding connection portion 288, the lower substrate holder 200 can realize the same effect as the lower substrate holder 200 including the lower sliding connection portion 272.

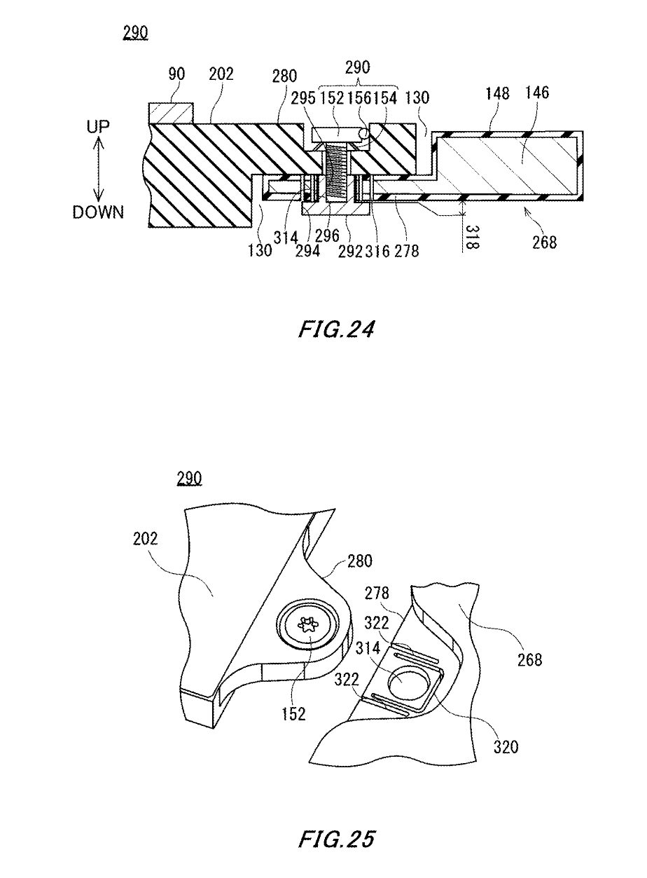

FIG. 24 is a vertical cross-sectional view of another lower sliding connection portion 290 along the line X4-X4 shown in FIG. 21. In FIG. 24, components that are the same as components in other drawings are given the same reference numerals, and redundant descriptions are omitted. As shown in FIG. 24, the lower sliding connection portion 290 includes a connecting bolt 152, a nut plate 292, a plate spring washer 154, and a locking member 156. The inner circumferential groove 278 of the lower ear portion 268 includes a through-hole 314 with a diameter slightly larger than the diameter of the small-diameter portion 296 of the nut plate 292 and a slit 316 provided around the through-hole 314. The length of the small-diameter portion of the nut plate 292 in the up and down direction is slightly greater than the thickness of the inner circumferential groove 278 of the lower ear portion, and therefore there is a small gap 318 providing a connection between the top plane of the large-diameter portion 294 of the nut plate 292 and the bottom surface of the inner circumferential groove 278. Accordingly, the lower ear portion 268 cannot move in the up and down direction, but can move relative to the mounting surface in a direction along the mounting surface, due to the slit 316 provided around the through-hole 314.

FIG. 25 is a perspective view for describing an exemplary lower sliding connection portion 290 shown in FIG. 24. In FIG. 25, components that are the same as components in other drawings are given the same reference numerals, and redundant descriptions are omitted. As shown in FIG. 25, the inner circumferential groove 278 of the lower ear portion 268 includes the through-hole 314, the slit 320, and two linear slits 322. The slit 320 surrounds the through-hole 314 on three sides, excluding the lower mounting portion 202 side. The two linear slits 322 are arranged extending from the lower mounting portion 202 side end, in a manner to sandwich the slit 320.

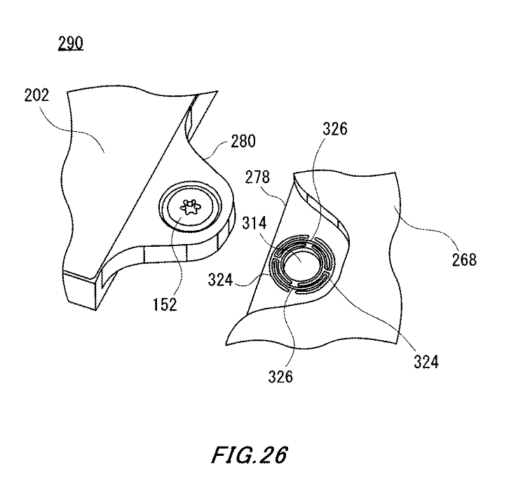

FIG. 26 is a perspective view for describing another example of the lower sliding connection portion 290 shown in FIG. 24. In FIG. 26, components that are the same as components in other drawings are given the same reference numerals, and redundant descriptions are omitted. As shown in FIG. 26, the inner circumferential groove 278 of the lower ear portion 268 includes a through-hole 314, two double semicircular slits 324, and two semicircular slits 326. The double semicircular slits 324 are concentric semicircles that have different diameters and have the centers thereof connected. The double semicircular slits 324 are arranged on the lower mounting portion 202 side and the opposite side, in a manner to surround the through-hole 314 with two semicircles. The semicircular slits 326 are slits that extend between the two semicircles of the double semicircular slits, and are arranged to cross over the two double semicircular slits 324.

The lower sliding connection portion 290 shown in FIGS. 25 and 26 has a plurality of slits surrounding the through-hole 314, and these slits enable the through-hole 314 to move in a direction along the mounting surface. Furthermore, the movement amount enabled by the plurality of slits is greater than the thermal expansion of the lower ear portion 268. The lower ear portion 268 is connected to the lower mounting portion by the nut plate 292, via a small gap in the up and down direction, and therefore the lower ear portion 268 cannot move in the up and down direction but can move relative to the mounting surface in a direction along the mounting surface.

By providing the lower sliding connection portion 290, even when the lower ear portion 268 expands due to heat, the thermal expansion can be absorbed by the inner circumferential groove 278 moving outward in the circumferential direction along the mounting surface. In this way, by providing the lower sliding connection portion 290, the lower substrate holder 200 can realize the same effect as the lower substrate holder 200 including the lower sliding connection portion 272.

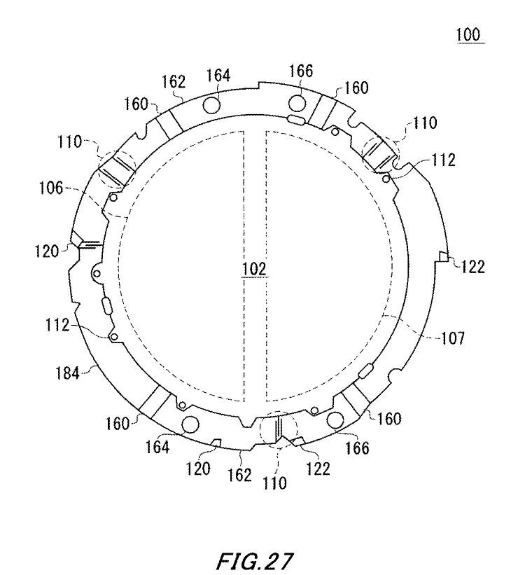

The following describes an embodiment in which a portion of the upper substrate holder 100 and the lower substrate holder 200 described above is altered. FIG. 27 is a top view of the altered upper substrate holder 100. In FIG. 27, components that are the same as components in other drawings are given the same reference numerals, and redundant descriptions are omitted. As shown in FIG. 27, in the upper substrate holder 100, the ring-shaped upper ear portion 184 is not separated, and is instead formed around the entire outer circumference of the upper mounting portion 102.

Upper elastic portions 160 are formed on the upper ear portion 184. The upper elastic portions 160 are formed at four locations on the upper ear portion 184. The upper elastic portions 160 are elastic in a direction perpendicular to the surface of the substrate 90, compared to other regions of the upper ear portion 184. Accordingly, each upper deformation region 162 sandwiched by two adjacent upper elastic portions 160 can deform more easily in the up and down direction than other regions.

The upper substrate holder 100 includes two pairs of upper electrostatic adhesion portions 164 and 166. The upper electrostatic adhesion portions 164 and 166 are examples of a connecting section. The upper electrostatic adhesion portions 164 and 166 are formed on the upper deformation region 162 of the upper ear portion 184. The pair of upper electrostatic adhesion portions 164 are electrically connected to the upper power supply terminal 120. One of the upper electrostatic adhesion portions 164 is charged with a positive charge by the power supplied from the upper power supply terminal 120. The other upper electrostatic adhesion portion 164 is charged with a negative charge by the power supplied from the upper power supply terminal 122.

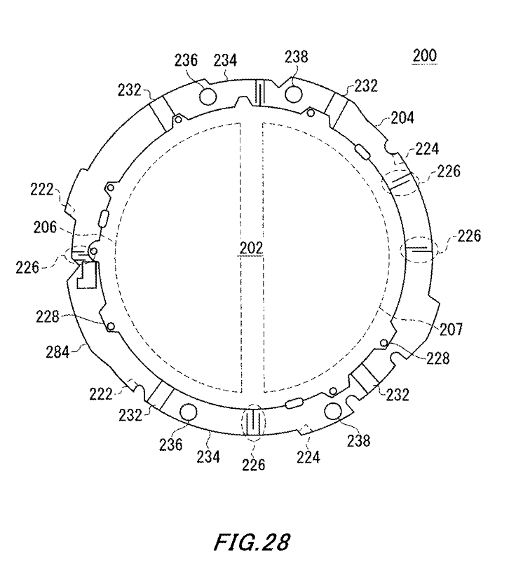

FIG. 28 is a top view of a lower substrate holder 200 with an altered portion, corresponding to the upper substrate holder 100 of FIG. 27. In FIG. 28, components that are the same as components in other drawings are given the same reference numerals, and redundant descriptions are omitted. As shown in FIG. 28, in the lower substrate holder 200, the ring-shaped lower ear portion 284 is formed around the entire outer circumference of the lower mounting portion 202.

Lower elastic portions 232 are formed on the lower ear portion 284. Lower deformation regions 234 are formed between each pair of adjacent lower elastic portions 232. The lower elastic portions 232 and the lower deformation regions 234 have the same structure as the upper elastic portions 160 and the upper deformation regions 162.

The lower substrate holder 200 includes two pairs of lower electrostatic adhesion portions 236 and 238. The lower electrostatic adhesion portions 236 and 238 are formed in the lower deformation region 234 of the lower ear portion 284. The lower electrostatic adhesion portions 236 are arranged at positions opposite the upper electrostatic adhesion portions 164, when the substrates 90 are in a held state. The pair of lower electrostatic adhesion portions 236 is charged with a negative charge by the lower power supply terminal 222. In this way, the pair of lower electrostatic adhesion portions 236 has a charge with different polarity than the opposing upper electrostatic adhesion portions 164, and therefore an electrostatic adhesive force is generated between the lower electrostatic adhesion portions 236 and the upper electrostatic adhesion portions 164. The pair of lower electrostatic adhesion portions 238 is charged with a positive charge by the lower power supply terminal 224. In this way, an electrostatic adhesive force is generated between the lower electrostatic adhesion portions 238 and the upper electrostatic adhesion portions 166. As a result, the upper substrate holder 100 and the lower substrate holder 200 are attracted to each other, thereby holding the pair of substrates 90.

Here, the upper elastic portions 160 and lower elastic portions 232 are respectively formed on the upper ear portion 184 and the lower ear portion 284. Accordingly, even through the lower electrostatic adhesion portions 236 and 238 and the upper electrostatic adhesion portions 164 and 166 attract each other, since the upper elastic portions 160 and the lower elastic portions 232 deform, damage to the upper substrate holder 100 and the lower substrate holder 200 can be restricted. In a state prior to the upper substrate holder 100 and the lower substrate holder 200 being connected to each other, the upper electrostatic adhesion portions 164 and 166 and the lower electrostatic adhesion portions 236 and 238 may be charged with the same polarity to repel each other.

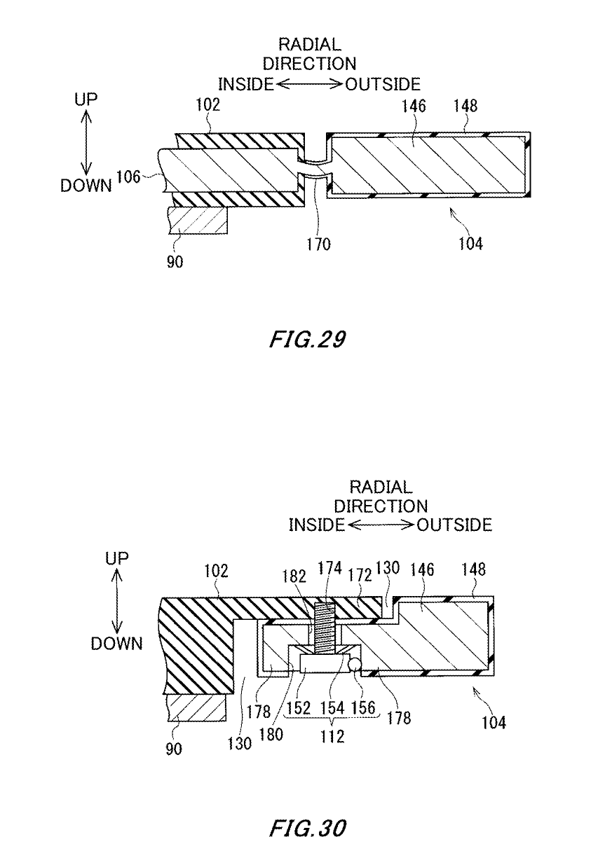

FIG. 29 is a vertical cross-sectional view for describing an exemplary connection between the upper electrode pad 106 and the frame 146. In FIG. 29, components that are the same as components in other drawings are given the same reference numerals, and redundant descriptions are omitted. FIG. 29 is a vertical cross-sectional view in the radial direction, near the inner circumferential portion of the upper ear portion 104 and the outer circumferential portion of the upper mounting portion 102. A connection member 170 is provided between the upper electrode pad 106 and the frame 146. The connection member 170 electrically connects the upper electrode pad 106 and the frame 146. The connection member 170 is formed integrally with the frame 146. The connection member 170 is curved to enable the upper ear portion 104 to move relative to the upper electrode pad 106. A ceramic film 148 is formed on the surface of the connection member 170 and the surface of the frame 146, using ceramic spray coating.

FIG. 30 is a vertical cross-sectional view of an embodiment in which the support structure of the upper mounting portion 102 and the upper ear portion 104 is altered. In FIG. 30, components that are the same as components in other drawings are given the same reference numerals, and redundant descriptions are omitted. As shown in FIG. 30, an outer circumferential groove 172 is formed on the top of the outer circumferential portion of the upper mounting portion 102. A bolt hole 174 is formed in the outer circumferential groove 172. An inner circumferential groove 178 is formed on the bottom of the inner circumferential surface of the upper ear portion 104. A large-diameter portion 180 and a small-diameter portion 182 are formed in the inner circumferential groove 178. In the present embodiment, the connecting bolt 152 is screwed into the bolt hole 174 formed in the upper mounting portion 102. Accordingly, the upper mounting portion 102 supports the inner circumferential edge of the upper ear portion 104. The upper connecting portion 112 biases the upper ear portion 104 to enable movement relative to the upper mounting portion 102 in the radial direction, while connecting the upper mounting portion 102 and the upper ear portion 104.

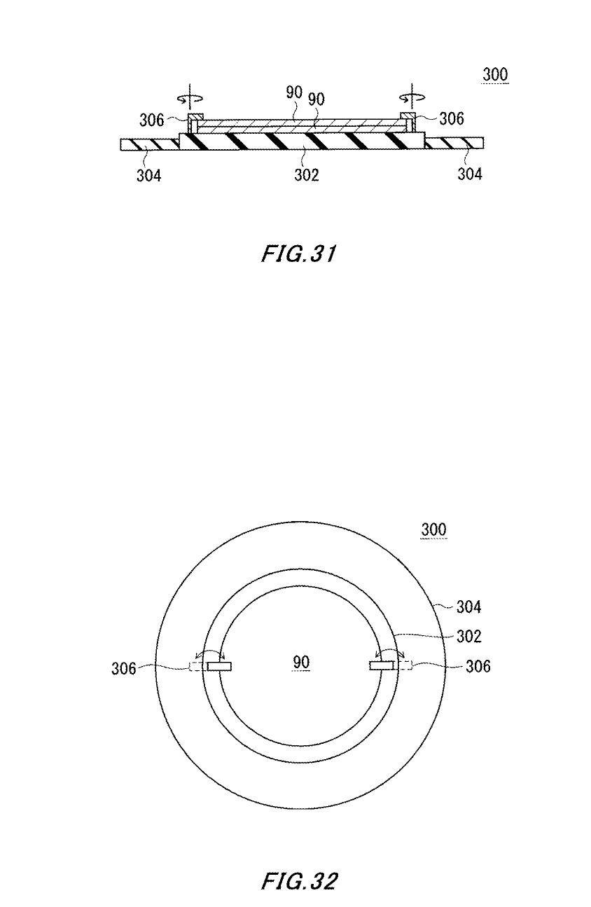

FIG. 31 is a side view of an embodiment in which a plurality of substrates 90 is sandwiched by a single substrate holder 300. FIG. 32 is a planar view of the substrate holder 300. As shown in FIGS. 31 and 32, the substrate holder 300 includes a mounting portion 302 and an ear portion 304. The absorbing section described above is formed on the ear portion 304, to reduce the difference in the amount of thermal expansion relative to the mounting portion 302. The mounting portion 302 is provided with a clamping section 306 that sandwiches the pair of substrates 90. The clamping section 306 is provided to be pivotable between a withdrawn position and a sandwiching position, around the up and down direction. The withdrawn position is a position in which the clamping section 306 is moved to a withdrawn position to enable transport of the substrate 90 onto the top surface of the mounting portion 302. The sandwiching position is a position in which the clamping section 306 pressing on the top surface of the substrate 90 mounted on the mounting portion 302, to enable sandwiching of the substrates 90 together with the mounting portion 302. In this way, when the substrate 90 is mounted on the top surface of the mounting portion 302, the clamping section 306 pivots from the withdrawn position to the sandwiching position. Therefore, the clamping section 306 can press the top surface of the substrate 90 that is stacked on another substrate 90. The clamping section 306 cam prevent misalignment between the substrate 90 and the other substrate 90 on which the substrate 90 is stacked, by sandwiching the substrates 90.

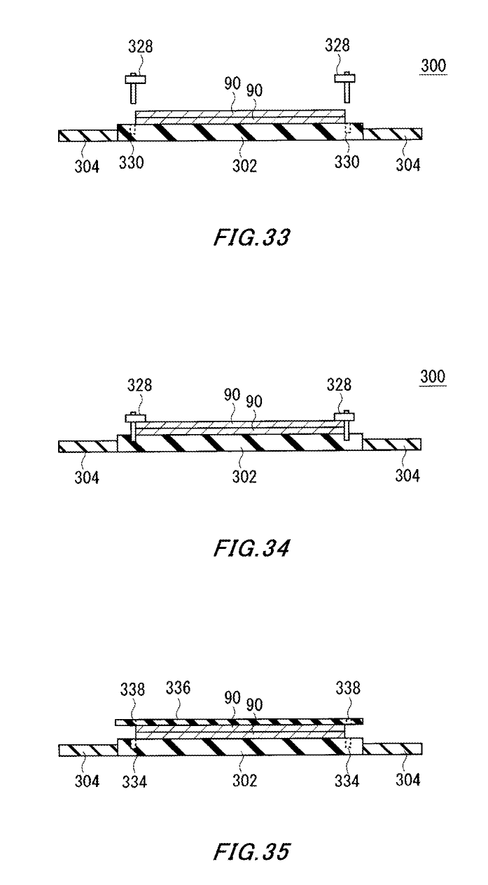

FIGS. 33 and 34 are side views for describing another example of sandwiching a plurality of the substrates 90 with a single substrate holder 300. FIG. 33 shows a state prior to sandwiching the pair of substrates 90 with pins 328.

The substrate holder 300 includes a mounting portion 302 and an ear portion 304. The absorbing section described above is formed on the ear portion 304 to reduce the difference in thermal expansion amount relative to the mounting portion 302. A recess 330, into which is inserted pins 328 for sandwiching the pair of substrates 90, is formed in the mounting portion 302 at two locations outward from the mounting surface on which the substrates 90 are mounted. After the pair of substrates 90 are mounted on the mounting surface, the pins 328 are inserted into the recess 330 to be fixed to the mounting portion 302. The pins 328 fixed to the mounting portion 302 press on the top surface of the pair of substrates 90, and sandwich the substrates 90 together with the mounting portion 302. This state is shown in FIG. 34. In this way, by sandwiching the pair of substrates 90 with the pins 328, misalignment can be prevented between the substrate 90 and the other substrate 90 aligned with the substrate 90.

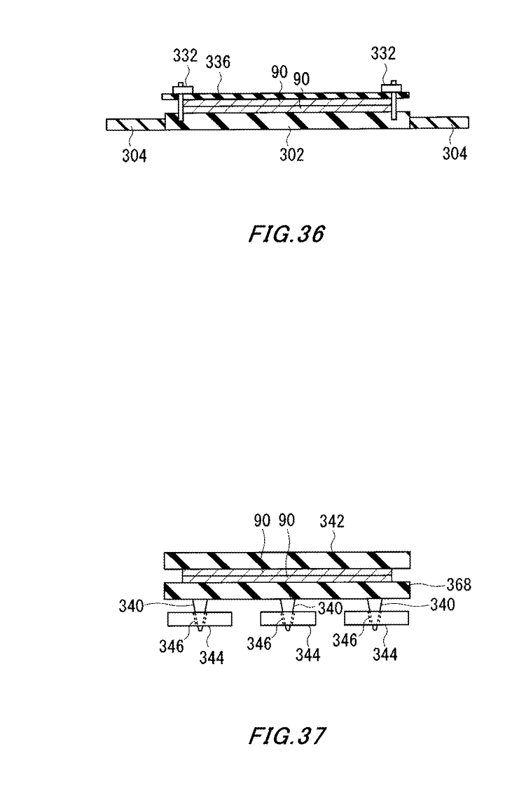

FIGS. 35 and 36 are side views for describing another example of sandwiching a plurality of the substrates 90 with a single substrate holder 300. In the same as the mounting portion 302 and the ear portion 304 shown in FIGS. 33 and 34, the substrate holder 300 has the pins 332 inserted into the mounting portion 302 and the recess 334 that fixes the pins 332 to the mounting portion 302. The absorbing section described above is formed on the ear portion 304, to reduce the difference in the thermal expansion amount relative to the mounting portion 302.

The pair of substrates 90 are mounted on the mounting surface of the mounting portion 302, and the board 336 is placed above the pair of substrates 90. The board 336 is an example of another member. This state is shown in FIG. 36. The board 336 is provided with through-holes 338. The pins 332 pass through the through-holes 338 of the board 336, to become inserted in the recess 334 formed in the mounting portion 302 and fixed. This state is shown in FIG. 37. In this way, the pair of substrates 90 are sandwiched by the board 336 and the pins 332 to prevent misalignment between the substrate 90 and the other substrate 90 aligned therewith.

In the examples of FIGS. 35 and 36, the substrate holder 300 is described with the board 336 and the pins 332 being separate, but the board 336 and the pins 332 may be formed integrally. The substrate holder 300 may include the board 336. The board 336 has a connection section with the clamping section shown in FIG. 31, and may press the pair of substrates 90 by connecting this connection section of the board 336 to the clamping section 306. Furthermore, the substrate holder 300 may use another substrate holder 300 instead of the board 336 pressing the pair of substrates.

FIG. 37 is a side view describing another example of the supported section. The lower mounting portion 368 includes three leg portions 340. The leg portions 340 are an example of a supported section. The leg portions 340 are shaped as vertically inverted cones. The three leg portions 340 are connected to the bottom surface of the lower mounting portion 368 at intervals of substantially 120 degrees around the center of mass of the lower mounting portion 368, in regions other than the mounting surface.

The pair of substrates 90 are sandwiched by the lower mounting portion 368 and the upper mounting portion 342. The adhesive structure connecting the lower mounting portion 368 and the upper mounting portion 342 may be an adhering section, a pair of clamps, or a pair of pins. On the other hand, the robot arm 344 may include conical through-holes 346 through which pass the leg portions 340, and the robot arm 344 may support the leg portions 340 by engaging the leg portions 340 in the through-holes 346. The leg portions 340 serve as a spacer, and the lower mounting portion 368 is transported at a distance from the robot arm 344.

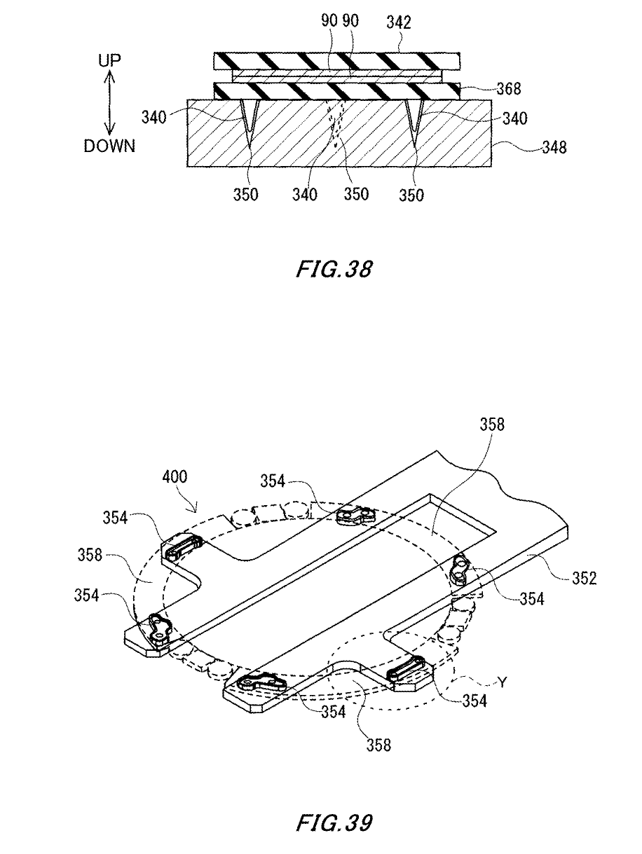

FIG. 38 is a side cross-sectional view for describing a state in which the lower mounting portion 368 and the upper mounting portion 342 of FIG. 37 are mounted on the thermocompression plate 348. As shown in FIG. 39, the recesses 350 corresponding to the positions of the leg portions 340 are provided in the thermocompression plate 348, and since the recesses 350 are larger than the leg portions 340, the leg portions 340 can fit entirely in the recesses 350. In other words, the leg portions 340 are connected to a portion other than a region affected by the pressure from the thermocompression plate 348. In a state where the bottom surface of the lower mounting portion 368 is in contact with the top surface of the thermocompression plate 348, the lower mounting portion 368 is mounted on the thermocompression plate 348.

The leg portion 340 expands downward due to heat, but since there is a gap between the recess 350 of the thermocompression plate 348 and the leg portion 340, the thermal expansion can be absorbed by this gap. Accordingly, the leg portions 340 are not damaged by the thermal expansion. The contact surface between the robot arm 344 and the leg portions 340 can be inclined according to the shape of the leg portions 340, thereby lessening the attachment of dust and the like to the leg portions 340 and the contact surface of the robot arm 344.

FIG. 39 is a perspective view describing a state in which the lower substrate holder 400 is transported to the robot arm 352. As shown in FIG. 39, the robot arm 352 includes six suction units 354. Two suction units 354 exert suction on the lower ear portion 358 separated into three pieces, and the lower substrate holder 400 is supported on the robot arm 352. The robot arm 352 is an example of a transporting section.

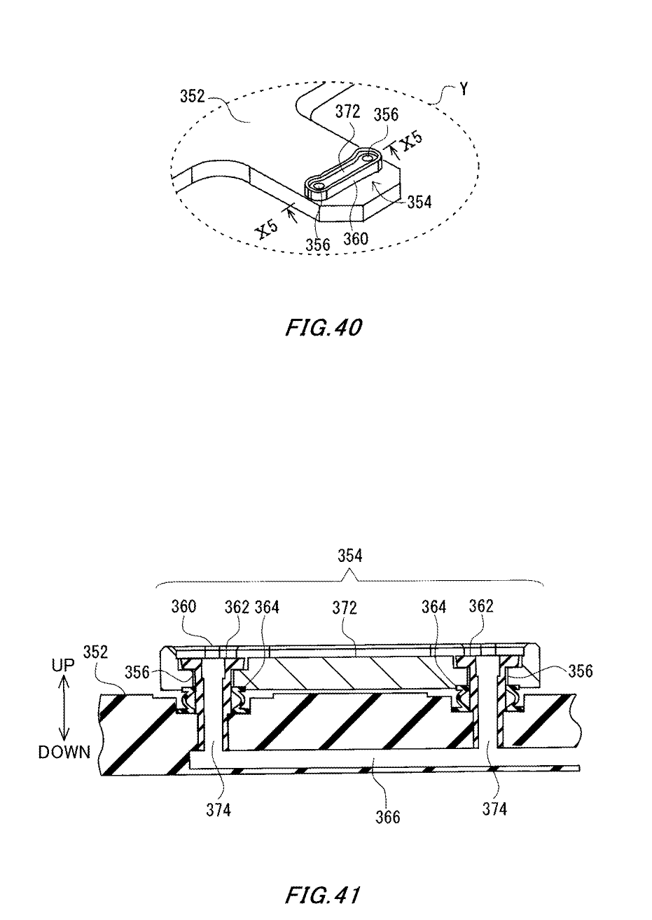

FIG. 40 is an enlarged perspective view of the region near the suction unit 354 surrounded by the dotted line Y in FIG. 39. As shown in FIG. 40, the suction unit 354 includes a suction pad 360. A recess 372 is formed in the top surface of the suction pad 360, and two through-holes 356 are formed in the floor surface of the recess 372. When the lower ear portion 358 is mounted on the suction pad 360, the recess 372 is sealed by the lower ear portion 358, and the recess 372 is closed tightly. The robot arm 352 reduces the pressure in the tightly sealed recess through the through-holes 356, thereby adhering the lower ear portion 358 to the suction pad 360. The suction pad 360 is fixed to the robot arm 352, and therefore the lower ear portion 358 is suctioned and fixed to the robot arm 352.

FIG. 41 is a vertical cross-sectional view over the line X5-X5 of FIG. 40, for describing the suction unit 354. As shown in FIG. 41, the suction unit 354 includes two cylindrical members 362 and two bellows 364s in addition to the suction pad 360.

The robot arm 352 is provided with two holes 374 connected to the negative-pressure source. The two cylindrical members 362 are inserted into the two through-holes 356 provided in the suction pad 360, from above. The inserted cylindrical members 362 engage with the two holes 374 of the robot arm 352, to be fixed to the robot arm 352 in a manner allowing upward movement. The cylindrical member 362 is connected to the negative-pressure source 366, and reduces the pressure of the recess 372 of the suction pad 360.

The suction pad 360 is supported on the top surface of the robot arm 352 via two bellows 364 having a bias. The two cylindrical bellows 364 are arranged between the suction pad 360 and the robot arm 352, in a manner to surround the cylindrical member 362. The bellows 364s bias the suction pad 360 upward against the robot arm 352, such that the suction pad 360 is supported at a distance above the top surface of the robot arm 352.

The suction pad 360 can move up and down and can be inclined back and forth or left and right, relative to the robot arm 352, by the bias force of the bellows 364. In other words, the bellows 364 are an example of a tilting mechanism that tilts the suction pad 360. The suction pad 360 can be inclined relative to the robot arm 352 in the up and down direction, the back and forth direction, and the left and right direction, and therefore the suction pad 360 can be inclined in any of these directions relative to the mounting surface of the lower substrate holder 400. In other words, at least one of the inclination and the height relative to the mounting surface of the lower substrate holder 400 can be changed by the suction unit 354. Furthermore, a bellows 364 can be arranged for each of a plurality of suction pads 360, and therefore a plurality of suction units 354 can independently change at least one of the height and the inclination relative to the mounting surface. By using the bellows 364 as the tilting mechanism, the impact occurring when the lower substrate holder 400 is mounted on the robot arm 352 can be lessened. In other words, the bellows 364 serves as a shock absorbing component. In this way, skew between the substrate and the substrate holder or the substrate and another substrate caused by impact during the mounting can be restricted.

The suction unit 354 can change the height and inclination relative to the mounting surface, and therefore even when the lower ear portion 358 experiences a tilt or height differential relative to the mounting surface, this tilt or height difference can be accounted for. Therefore, the suction unit 354 does not allow gaps to occur between itself and the lower ear portion 358. The suction unit 354 reliably exerts suction on the lower ear portion 358 to fix the lower ear portion 358 to the surface of the robot arm 352.

In the above embodiments, the absorbing section is provided between the upper mounting portion 102 and the upper ear portion 104, but a restricting section that restricts damage due to a difference in thermal expansion amount is not limited to this suction unit. As other examples of restricting sections, there may be a section that restricts damage from stress caused by a difference in the thermal expansion amount, by causing the upper ear portion 104 itself to have a thermal expansion coefficient greater than the thermal expansion coefficient of the upper mounting portion 102. The thermal expansion coefficient of the upper mounting portion 102 and the thermal expansion coefficient of the upper ear portion 104 are constant in each component, but the thermal expansion coefficient may instead change in the radial direction. For example, the thermal expansion coefficient of the upper mounting portion 102 may gradually become larger in a direction radially outward. Furthermore, the thermal expansion coefficient of the upper ear portion 104 may gradually become larger in a direction radially outward. The outer circumference of the upper ear portion 104 also radiates heat from the side surfaces, and therefore it is possible to reduce the difference in the thermal expansion amount between the outer circumference and the inner circumference of the upper ear portion 104 by increasing the thermal expansion coefficient of the outer circumference. Furthermore, the linear thermal expansion amount of the upper mounting portion 102 and the linear thermal expansion amount of the upper ear portion 104 may be equal in the radial direction. In this way, the difference between linear thermal expansion amount of the upper mounting portion 102 and the linear thermal expansion amount of the upper ear portion 104 can be eliminated. For example, thermal expansion coefficients of the upper mounting portion 102 and the upper ear portion 104 may be set such that the difference between the temperature of the upper mounting portion 102 and the temperature of the upper ear portion 104 caused by the thermocompression apparatus 56 causes the linear thermal expansion amounts to be equal.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### LIST OF REFERENCE NUMERALS

substrate bonding apparatus: 10, 12: environment chamber, 14: atmosphere environment section, 16: vacuum environment section, 18: control section, 20: substrate cassette, 22: substrate holder rack, 24: robot arm, 26: pre-aligner, 28: aligner, 30: robot arm, 34: frame, 36: fixed stage, 38: movable stage, 40: shutter, 42: shutter, 48: load lock chamber, 50: access door, 52: gate valve, 53: robot chamber, 54: robot arm, 55: housing chamber, 56: thermocompression apparatus, 57: gate valve, 58: robot arm, 60: cooling room, 90: substrate, 92: multilayered substrate, 100: upper substrate holder, 102: upper mounting portion, 104: upper ear portion, 106: upper electrode pad, 107: upper electrode pad, 108: adhering section, 110: upper absorbing portion, 112: upper connecting portion, 114: upper connecting member, 116: adhesion member, 120: upper power supply terminal, 122: upper power supply terminal, 124: upper ear piece, 126: notch, 127: dummy notch, 128: slit, 130: gap, 132: outer circumferential groove, 134: large-diameter portion, 136: small-diameter portion, 140: inner circumferential groove, 144: bolt hole, 146: frame, 148: ceramic film, 152: connecting bolt, 154: plate spring washer, 156: locking member, 160: upper elastic portion, 162: upper deformation region, 164: upper electrostatic adhesion portion, 166: upper electrostatic adhesion portion, 170: connection member, 172: outer circumferential groove, 174: bolt hole, 178: inner circumferential groove, 180: large-diameter portion, 182: small-diameter portion, 184: upper ear portion, 186: upper ear portion, 188: upper fastening portion, 190: upper locking portion, 192: upper ear portion, 194: upper fastening portion, 196: upper sliding connection portion, 200: lower substrate holder, 202: lower mounting portion, 204: lower ear portion, 206: lower electrode pad, 207: lower electrode pad, 208: adhered portion, 210: notch, 212: dummy notch, 214: lower connecting member, 216: lower elastic member, 218: adhered member, 220: lower ear piece, 222: lower power supply terminal, 224: lower power supply terminal, 226: lower suction portion, 228: lower connecting portion, 232: lower elastic portion, 234: lower deformation region, 236: lower electrostatic adhesion portion, 238: lower electrostatic adhesion portion, 240: lower ear portion, 248: lower fastening portion, 250: lower locking portion, 258: lower locking portion, 260: recess, 262: protrusion, 264: protrusion, 266: recess, 268: lower ear portion, 270: lower fastening portion, 272: lower sliding connection portion, 278: inner circumferential groove, 280: outer circumferential groove, 282: gap, 284: lower ear portion, 286: gap, 288: lower sliding connection portion, 290: lower sliding connection portion, 292: nut plate, 294: large-diameter portion, 295: bolt hole, 296: small-diameter portion, 298: large-diameter portion, 300: substrate holder, 302: mounting portion, 304: ear portion, 306: clamping section, 308: small-diameter portion, 310: gap, 312: gap, 314: through-hole, 315: gap, 316: slit, 318: gap, 320: slit, 322: linear slit, 324: double semicircular slit, 326: semicircular slit, 328: pin, 330: recess, 332: pin, 334: recess, 336: board, 338: through-hole, 340: leg portion, 342: upper mounting portion, 344: robot arm, 354: suction unit, 356: through-hole, 358: lower ear portion, 360: suction pad, 362: cylindrical member, 364: bellows, 366: negative-pressure source, 368: lower mounting portion, 372: recess, 374: hole, 400: lower substrate holder

What is claimed is:

1. A substrate holder that holds a substrate when the substrate is being aligned with another substrate and transports the substrate in a held state, comprising:
a mounting portion on which the substrate is mounted;
a supported section that is provided on the mounting portion and is supported by another member during transport; and
a restricting section that restricts damage from stress caused by a difference in expansion and contraction due to heat between the mounting portion and the supported section.

2. The substrate holder according to claim 1, wherein
the restricting section includes an absorbing section that absorbs a difference in expansion and contraction due to heat between the mounting portion and the supported section.

3. The substrate holder according to claim 2, wherein
the supported section is arranged around the mounting portion, and
the absorbing section absorbs deformation of the supported section along a circumferential direction of the mounting portion when the mounting portion expands and contracts due to heat.

4. The substrate holder according to claim 2, wherein
the absorbing section includes a slit formed in the supported section.

5. The substrate holder according to claim 2, wherein
the supported section is supported by a circumferential edge of the mounting portion, and
the absorbing section is biased such that the mounting portion is moveable in a radial direction relative to the supported section.

6. The substrate holder according to claim 2, wherein
the absorbing section provides an elastic connection between the mounting portion and the supported section.

7. The substrate holder according to claim 2, wherein
the absorbing section has a gap between the mounting portion and the supported section in the radial direction.

8. The substrate holder according to claim 1, comprising:
a clamping section that is provided on the mounting portion and presses the other substrate against the substrate, in order to prevent misalignment between the substrate mounted on the mounting portion and the other substrate aligned with the substrate.

9. The substrate holder according to claim 1, comprising:
a clamping section that is provided on the mounting portion and connected to another member, in order to sandwich the substrate between the mounting portion and the other member.

10. The substrate holder according to claim 9, wherein
the other member is another substrate holder that holds another substrate aligned with the substrate.

11. The substrate holder according to claim 10, wherein
the other member is a board that is mounted on the other substrate aligned with the substrate and has a bonding portion that connects to the clamping section.

12. The substrate holder according to claim 1, wherein
the supported section includes a plurality of ear pieces that are spaced from each other and connected to a circumferential edge of the mounting portion.

13. The substrate holder according to claim 1, wherein
the mounting portion is provided with an electrostatic pad that holds the substrate, and
the supported section is formed of a material including conductive metal and is electrically connected to the electrostatic pad.

14. The substrate holder according to claim 1, wherein
the supported section includes a connecting section that is elastic in a direction perpendicular to a surface of the substrate and connects, via electrostatic adhesion, to a portion of another substrate holder when the substrate is sandwiched between the supported section and the other substrate holder.

15. The substrate holder according to claim 1, wherein
the restricting section is a portion of the supported section that has a thermal expansion coefficient greater than a thermal expansion coefficient of the mounting portion.

16. The substrate holder according to claim 1, wherein
a thermal expansion coefficient of the mounting portion changes in a radial direction.

17. The substrate holder according to claim 1, wherein
a linear thermal expansion amount of the supported section in a radial direction is equal to a thermal expansion amount of the mounting portion in the radial direction.

18. The substrate holder according to claim 1 wherein,
the supported section is connected in a manner to be movable relative to the mounting portion in a direction along a mounting surface on which the substrate is mounted and to restrict movement relative to the mounting surface in a direction perpendicular to the mounting surface.

19. A substrate holder that holds a substrate, comprising:
a mounting portion on which the substrate is mounted;
a supported section that is provided around the mounting portion and is supported by another member; and
an absorbing section that absorbs deformation of the supported section in a circumferential direction of the mounting portion when the mounting portion expands and contracts due to heat.

20. A substrate bonding apparatus comprising:
the substrate holder according to claim 1; and
a bonding section that bonds a plurality of the substrates, in a state where the substrates are held by the substrate holder.
